(19) United States
(12) Patent Application Publication
(10) Pub. No.: US 2026/0249148 A1
(43) Pub. Date: Aug. 27, 2026

(54) 3-Dimensional Printed Sporting Implement and Method of Manufacture Thereof

(71) Applicant: Vanquish Hockey Limited, Calgary (CA)

(72) Inventors: Tory Weber, Calgary (CA); Eric Lemieux, Calgary (CA); Martin Chambert, Calgary (CA); Michel Chiasson, Calgary (CA); Mariane Boisvert-Valencia, Calgary (CA)

(21) Appl. No.: 19/489,664

(22) PCT Filed: Jun. 28, 2024
(86) PCT No.: PCT/CA2024/050879

§ 371 Date: Dec. 3, 2025

Related U.S. Application Data
(60) Provisional application No. 63/510,683, filed on Jun. 28, 2023.
(60) Provisional application No. 63/573,105, filed on Apr. 2, 2024.

(51) Int. Cl. A63B 59/70; A42B 3/20; A43B 5/16; A63B 49/02; A63B 60/08; A63B 102/02; A63B 102/24; A63B 102/32; B33Y 80/00

(52) U.S. Cl. CPC A63B 59/70; A42B 3/20; A43B 5/16; A63B 49/02; A63B 60/08; A63B 2102/02; A63B 2102/24; A63B 2102/32; B33Y 80/00

(57) ABSTRACT

A sporting implement for use in playing a sport includes a frame assembly defining a structural frame of the sporting element in which the structural frame is formed of a customizable dimensional printed structure. In the instance of an implement with a shaft and a tool at one end of the shaft such as the blade at the end of a hockey stick, the shaft may be formed as a lattice frame with a feature of the lattice varying as a gradient along a length of the shaft. A filament wrap with optionally varying characteristics or plastic inserts may also be provided about the lattice frame to further customize the performance of the implement.

### FIELD OF THE INVENTION

The present invention relates to sporting implements, for example hockey sticks, skates and protective equipment, and more particularly, the present invention relates to sporting implements formed by 3-dimensional printing, otherwise known as additive manufacturing, and including lattice structures to enable customization of various structures and performance parameters of the sporting implements.

### BACKGROUND

In the design of sporting implements, it is desirable for various playing equipment such as hockey sticks, tennis rackets, bicycle frames, etc. and protective equipment such as helmets, guards and the like to be designed with minimal weight while retaining sufficient strength to maximize performance. One common construction used in sporting implements includes the use of fibre and resin composite materials together with polymer foam materials to occupy interior cavities. The performance of such equipment is limited to the performance characteristics of the materials used.

U.S. Pat. No. 9,925,440 by Bauer Hockey Inc. discloses a sporting good implement, such as a hockey stick or ball bat, that includes a main body. The main body may be formed from multiple layers of a structural material, such as a fiber-reinforced composite material. One or more microlattice structures may be positioned between layers of the structural material. One or more microlattice structures may additionally or alternatively be used to form the core of a sporting good implement, such as a hockey-stick blade. The microlattice structures can improve the performance, strength, or feel of the sporting good implement; however, the combination of structures used results in a complex manufacturing process involving numerous steps and diverse labor skills.

### SUMMARY OF THE INVENTION

According to a first aspect of the invention there is provided a sporting implement for use in playing a sport, the sporting implement comprising:
a frame assembly defining a structural frame of the sporting element;
wherein the structural frame is formed of a customizable 3-dimensional printed structure.

For example, the frame assembly may define the structural frame of a hockey stick, a cricket bat a, a baseball bat, a golf club, a tennis racket, a bicycle chassis, and the like.

By forming the structural frame as a uniform 3-dimensional printed structure, the entire frame can be manufactured in a single process, while being highly customizable without any substantial increase in complexity to the manufacturing process.

According to a second aspect there is provided a method of manufacturing the sporting implement described above comprising:
receiving one or more user selections relating to a configuration of the sporting element;
modifying 3-dimensional printing instructions according to the one or more user selections relating to the configuration of the sporting implement; and
printing the 3-dimensional printed structure according to the modified 3-dimensional printing instructions.

According to another aspect of the invention there is provided a hockey stick comprising:
a shaft arranged to be gripped by a user; and
a blade extending transversely from one end of the shaft;
wherein the shaft and the blade are formed of a customizable 3-dimensional printed structure.

According to a further aspect of the present invention there is provided a method of manufacturing the hockey stick described above, the method comprising:
receiving one or more user selections relating to a configuration of the hockey stick;
modifying 3-dimensional printing instructions according to the one or more user selections relating to the configuration of the hockey stick; and
printing the 3-dimensional printed structure according to the modified 3-dimensional printing instructions.

The implement may include the 3-dimensional printed structure forming the shaft, wherein exterior boundary walls of the shaft are defined by the lattice structure such that the lattice structure remains exposed at the boundary walls along a length of the shaft.

When a cross sectional shape of the shaft is rectangular so as to define four corner edges, the 3-dimensional lattice structure may include a corner member spanning continuously along the length of the shaft at each of the four corner edges.

Preferably at least one size attribute of the lattice structure varies gradually along a gradient portion of the length of the shaft.

The 3-dimensional printed structure may include a 3-dimensional lattice structure forming boundary walls of the sporting tool.

The 3-dimensional printed structure may be formed of metal or composite, and may comprises para-aramid fibers.

When the shaft comprises boundary walls forming an outer tube extending in a longitudinal direction along a length of the shaft, stiffener flanges may protrude inwardly from the boundary walls partway across a hollow interior of the outer tube. The stiffener flanges may be oriented transversely to the longitudinal direction and arranged in a repeating array pattern along the length of the shaft.

The shaft may comprise boundary walls forming an outer tube extending in a longitudinal direction along a length of the shaft and a plurality of dimples formed by the 3-dimensional printed structure in a grid pattern within the boundary walls to protrude inwardly into a hollow interior of the outer tube.

The shaft may comprise boundary walls forming an outer tube extending in a longitudinal direction along a length of the shaft and a plurality of openings formed by the 3-dimensional printed structure in a grid pattern within the boundary walls. Stiffener flanges may protrude inwardly from the boundary walls, wherein at least some of the stiffener flanges comprise annular flanges in which each annular flange surrounds a respective one of the openings in the boundary walls of the shaft to protrude inwardly from an inner surface of the boundary walls.

When the sporting implement is a hockey stick and the sporting tool is a blade comprising a front face, a rear face, a plurality of openings may be formed by the 3-dimensional printed structure so as to extend through the blade between the front face and the rear face in a grid pattern.

The 3-dimensional printed structure may define boundary walls of the shaft forming an outer tube extending in a longitudinal direction along a length of the shaft, in which each boundary wall comprises (i) a plurality of structural nodes arranged in a 2-dimensional array; and (ii) a plurality of struts extending in a direction of the 2-dimensional array and being interconnected between respective pairs of the structural nodes of the 2-dimensional array; wherein at least some of the struts comprises overlapping struts that each overlap transversely across a different corresponding one of the overlapping struts so as to allow relative movement between the overlapping struts.

When the sporting implement is a hockey stick and the sporting tool is a blade, the 3-dimensional printed structure may comprise (i) a first printed structure including the blade and a first shaft section forming a first lengthwise portion of the shaft, and (ii) a second printed structure including a second shaft section forming a second lengthwise portion of the shaft, the first and second structures being arranged for mating connection with one another to define the sporting implement.

One of the first printed structure and the second printed structure may comprise a male connector formed thereon as part of the 3-dimensional printed structure and another one of the first printed structure and the second printed structure comprises a female connector formed thereon as part of the 3-dimensional printed structure, the male connector and the female connector forming said mating connection. A perimeter groove may be formed to extend at least partway about a circumferent of the shaft at a junction between the first and second printed sections when the first and second printed sections are joined in abutment with one another, wherein the perimeter groove is filled with a weld material which is identical to a material of the first and second printed sections so as to immovably fix the first and second printed sections relative to one another.

The shaft of the 3-dimensional printed structure may include an outer boundary surface and grooves integrally formed therein which are recessed relative to the outer boundary surface and which define indicia representing letters or numbers.

The shaft of the 3-dimensional printed structure may include an outer boundary surface and protruding members integrally formed thereon which protrude relative to the outer boundary surface and which enhance user grip about the shaft.

The protruding members may be located at an intermediate location partway along the shaft between the sporting tool and an opposing end of the shaft or located in proximity to one end of the shaft opposite from the sporting tool.

When the sporting implement comprises a goalie hockey stick and the sporting tool comprises a blade, and the shaft may comprise a lower paddle portion adjacent the blade and an upper gripping portion extending above lower paddle portion, wherein the upper gripping portion is narrower in width than the lower paddle portion, and wherein the protruding members are located on the upper gripping portion in proximity to the lower paddle portion.

When the sporting implement comprises a goalie hockey stick and the sporting tool comprises a blade formed with the shaft as part of the 3-dimensional printed structure, and the blade of the 3-dimensional printed structure may include (i) an outer boundary surface and (ii) protruding members integrally formed thereon which protrude relative to the outer boundary surface, the protruding members providing enhanced grip to the outer boundary surface of the blade.

The 3-dimensional printed structure may comprise a lattice frame formed of metal and extending along a length of the shaft, wherein the sporting implement further comprises at least one reinforcement strip wrapped about a portion of the lattice frame, said at least one reinforcement strip being formed of a composite fibre and resin material which extends as a unitary member along a majority of a length of the shaft.

When the sporting implement comprises a hockey stick and the sporting tool comprises a blade formed with the shaft as part of the 3-dimensional printed structure, the printed structure of the blade may further comprise at least one recess in a surface of the blade, and the sporting implement further comprising a plastic insert mounted into the recess to define a portion of an exterior surface of the blade.

According to another aspect of the present invention there is provided a blade holder for mounting a skate blade onto a skate boot, the blade holder comprising:
a lower blade mounting portion arranged to mount the skate blade thereon; and
an upper boot mounting portion arranged to be mounted onto a bottom of the skate boot;
wherein the lower blade mounting portion and the upper boot mounting portion are joined as a unitary body formed of a customizable 3-dimensional printed structure.

Said unitary body formed of the customizable 3-dimensional printed structure may include the skate blade. The skate blade may include (i) an upper portion joined to the blade holder and extending along at least a portion of a length of the blade in which the upper portion comprises a 3-dimensional lattice structure, and (ii) a lower portion below the upper portion to define a bottom edge of the blade, in which the lower portion is solid along the length of the blade.

The upper boot mounting portion may include a front pedestal and a rear pedestal arranged to be joined to the skate boot at spaced apart locations, in which each pedestal comprises a tubular boundary wall defining a hollow column and a plurality of wall openings formed in the tubular boundary wall at spaced apart locations in an array pattern, the tubular boundary wall and the wall openings being formed as part of the 3-dimensional printed structure.

A plurality of stiffener flanges may protrude inwardly from the tubular boundary wall partway across a hollow interior of the hollow column, the stiffener flanges being situated between the openings in the tubular boundary wall.

Some of the stiffener flanges may comprise annular flanges, each annular flange surrounding a respective one of the wall openings in the tubular boundary wall to protrude inwardly from an inner surface of the tubular boundary wall.

An alignment tool may be provided comprising an elongate mounting member and an elongate guide member joined perpendicularly to one another, wherein the blade holder comprises a first horizontal socket formed at a toe end of the blade holder and a second horizontal socket formed at a heel end of the blade holder, each socket being arranger to receive the mounting member of the alignment tool longitudinally slidably therein such that the guide member extends vertically upwardly therefrom to locate a lateral center of the blade holder relative to the skate boot.

According to a further aspect of the present invention there is provided a method of manufacturing the blade holder described above, the method comprising:
receiving one or more user selections relating to a configuration of the blade holder, the user selections including a blade profile radius, a fastener pattern of the upper boot mounting portion, a heel height, and/or a radius of an edge of the blade;
modifying 3-dimensional printing instructions according to the one or more user selections relating to the configuration of the blade holder; and
printing the 3-dimensional printed structure according to the modified 3-dimensional printing instructions.

According to another aspect of the present invention there is provided a hockey goalie mask comprising:
a main body portion arranged to be worn about a head of a user so as to cover a jaw, a forehead, and temporal regions of the head of the user, the main body portion including a viewing region comprising a plurality of viewing openings for alignment with eyes of the user when the main body portion is worn about the head of the user; and
at least one elongate member spanning across the viewing region between respective ones of the viewing openings so as to define at least part of the boundary of said respective ones of the viewing openings;
wherein the main body portion and said at least one elongate member are joined as a unitary body formed of a customizable 3-dimensional printed structure.

The main body portion and the at least one bar member may be formed continuously with one another from a common metallic material.

According to a further aspect of the present invention there is provided a method of manufacturing the hockey goalie mask as described above, the method comprising:
receiving one or more user selections relating to a configuration of the hockey goalie mask, the user selections including a shape of the main body portion, a configuration of the viewing openings, and/or a configuration of said at least one elongate member;
modifying 3-dimensional printing instructions according to the one or more user selections relating to the configuration of the hockey goalie mask; and
printing the 3-dimensional printed structure according to the modified 3-dimensional printing instructions.

According to another aspect of the present invention there is provided a sporting implement comprising:
a shaft arranged to be gripped by a user; and
a sporting tool protruding from one end of the shaft;
wherein the shaft comprises (i) a lattice frame formed of a 3-dimensional printed lattice structure and extending along a length of the shaft, and (ii) at least one reinforcement strip wrapped about a portion of the lattice frame; and
wherein said at least one reinforcement strip is formed of a composite fibre and resin material which extends as a unitary member along a majority of a length of the shaft.

The at least one reinforcement strip may comprise a flat band of material including continuous fibre members spanning a full length of the reinforcement strip.

Preferably the shaft and the sporting tool are both formed of said lattice frame and said at least one reinforcement strip is wrapped helically about the lattice frame.

The lattice frame may be formed in sections spanning respective portions of the length of the shaft and wherein said at least one reinforcement strip extends continuously across the sections of the core to bridge the sections.

The at least one reinforcement member preferably extends helically about the frame. A helix angle of said at least one reinforcement strip may vary along the length of the shaft. A lower portion of the shaft adjacent to the sporting tool may have a different helix angle from an upper portion of the shaft distal from the sporting tool.

The lattice frame may include at least one channel recessed into an exterior boundary of the lattice frame, said at least one channel receiving said at least one reinforcement strip at least partially recessed therein. Preferably said at least one reinforcement strip is fully recessed within said at least one channel.

Said at least one reinforcement strip may be flush mounted relative to the exterior boundary of the lattice frame along at least an intermediate portion of the shaft at an intermediate location along the length of the shaft.

Said at least one reinforcement strip may be recessed relative to boundary walls of said at least one channel along at least a portion of the length of the shaft.

At least one protruding rib may be formed integrally with the lattice core and extending alongside said at least one channel, in which said at least one protruding rib protrudes outwardly from the exterior boundary of the core.

A plurality of openings may be formed in boundary walls of said at least one channel and receiving resin of said composite fibre and resin material at least partially therein.

Said at least one channel in cross section along a plane extending longitudinally along the shaft may define a pair of longitudinally opposed boundary walls which are sloped outwardly in a common direction longitudinally of the shaft.

A plurality of impact resistant members may be supported externally on the shaft along a lower portion of the shaft adjacent to the sporting tool so as to extend externally over a portion of said at least one reinforcement strip.

According to a further aspect of the present invention there is provided a sporting implement comprising:
a shaft arranged to be gripped by a user and being formed at least in part with a composite fibre and resin material;
a sporting tool protruding from one end of the shaft; and
at least one impact resistant member formed of plastic material and supported externally on (i) the shaft along a lower portion of the shaft adjacent to the sporting tool or (ii) on the sporting tool so as to extend externally over said composite fibre and resin material.

The at least one impact resistant member may comprise a plurality of impact resistant members supported on the shaft and connected to one another by flexible strands extending longitudinally of the shaft.

The at least one impact resistant member is preferably mechanically coupled to the shaft or the sporting tool so as to be releasable from the shaft or the sporting tool.

According to another aspect of the present invention there is provided a sporting implement comprising:
a shaft arranged to be gripped by a user, the shaft comprising a lattice frame extending along a length of the shaft, in which the lattice frame is formed of a 3-dimensional printed lattice structure; and
a sporting tool formed at one end of the shaft;
wherein at least one of a geometry and a density of the lattice frame varies gradually along a gradient portion of the length of the shaft.

Said at least one of the geometry and the density is preferably a size attribute of the lattice frame which varies gradually along said gradient portion of the length of the shaft.

Said at least one size attribute of the lattice frame may correspond to a beam diameter of beams aligned in one axial direction, the beam diameter of the beams along said one axis varying in thickness gradually along said gradient portion of the length of the shaft.

Alternatively, said at least one size attribute of the lattice frame may correspond to a beam diameter of beams aligned in a plurality of different axial directions, the beam diameter of the beams along said plurality of different axial directions varying in thickness gradually along said gradient portion of the length of the shaft.

Said size attribute may vary linearly along the gradient portion of the length of the shaft.

Preferably an exterior profile of the shaft remains constant along said gradient portion of the length of the shaft.

When the sporting implement comprises a hockey stick and the sporting tool comprises a blade, preferably said gradient portion of the length of the shaft is proximate to the blade.

When the shaft is formed in sections spanning respective portions of the length of the shaft and joined to one another at one or more junctions, said gradient portion of the length of the shaft is preferably wholly contained within one of the sections of the shaft.

According to another aspect of the present invention there is provided a sporting implement comprising:
a shaft arranged to be gripped by a user, the shaft comprising a lattice frame extending along a length of the shaft, in which the lattice frame is formed of a 3-dimensional printed lattice structure; and
a sporting tool formed at one end of the shaft;
wherein the shaft is formed in shaft sections spanning respective portions of the length of the shaft and being joined to one another at one or more junctions between corresponding adjacent pairs of the shaft sections; and
wherein each junction further comprises:
   a male connector formed on one of the shaft sections of the corresponding adjacent pair;
   a female connector formed on another one of the shaft sections of the corresponding adjacent pair, the female connector receiving the male connector slidably therein longitudinally of the shaft; and
   a perimeter groove extending circumferentially at least partway about the shaft when the male connector is fully inserted into the female connector;
   wherein the perimeter groove has boundary surfaces defined in part on both shaft sections of the corresponding adjacent pair whereby a bead of weld material received within the perimeter groove immovably fixes the shaft sections relative to one another.

Preferably the bead of weld material is formed of the same material as the shaft sections and fills the perimeter groove of the respective junction such that an exterior profile of the shaft is continuous across the junction between the shaft sections.

Each junction may further comprise a rib protruding from one of the shaft sections alongside the perimeter groove, the rib being formed integrally as part of the 3-dimensional printed lattice structure, and the rib being sized to form a weld bead that substantially fills the perimeter groove upon application of heat to reform the rib into the weld bead.

Each junction may further include the rib being formed on the shaft section having the male connector formed thereon.

Each junction may further comprise a stop formed on one of the shaft sections so as to longitudinally abut a corresponding portion of the other one of the shaft sections when the male connector is fully inserted into the female connector.

Each junction may further comprise a mechanical connector to resist removal of the male connector from the female connector once the male connector has been fully inserted into the female connector.

According to a further aspect of the present invention there is provided a sporting implement comprising:
a shaft arranged to be gripped by a user, the shaft comprising a lattice frame extending along a length of the shaft, in which the lattice frame is formed of a 3-dimensional printed lattice structure; and
a sporting tool defining a hockey blade formed at one end of the shaft as part of the 3-dimensional printed structure, in which the 3-dimensional printed structure of the blade further comprises at least one recess in a surface of the blade;
a plastic insert mounted into the recess to define a portion of an exterior surface of the blade.

An exterior surface of the plastic insert may be substantially flush with an exterior surface of an adjacent portion of the lattice frame.

The insert may be fixed to the lattice frame by a mechanical coupling. Furthermore, the insert may be fixed to the lattice frame solely by the mechanical coupling and wherein the mechanical coupling is readily releasable.

The surface of the blade locating the recess therein may include a portion of a concave front face of the blade and/or a portion of a convex rear face of the blade.

The surface of the blade locating the recess therein may include a portion of a concave front face of the blade, a portion of a convex rear face of the blade, and a portion of a bottom edge of the blade between the front face and the rear face, such that the insert comprises a single body having a generally U-shaped profile received within respective portions of the recess in the front face, the bottom edge and the rear face respectively.

The bottom edge may further include a primary surface oriented transversely to the front and rear faces and at least one protrusion protruding longitudinally of the shaft from the primary surface. The at least one protrusion on the bottom edge may comprise a rib extending along a majority of a length of the blade.

The insert may further include a primary surface defining at least a portion of a concave front face or a convex rear face of the blade and a plurality of spaced apart gripping protrusions protruding outwardly from the primary surface at spaced apart locations to define a gripping texture. A spacing between adjacent gripping protrusions may vary across the primary surface of the insert.

### BRIEF DESCRIPTION OF THE DRAWINGS

Various embodiments of the invention will now be described in conjunction with the accompanying drawings in which:

FIG. 1A is schematic representation of a player hockey stick according to one embodiment of the sporting implement according to the present invention;

FIG. 1B is a schematic representation of a goalie hockey stick according to a further embodiment of the sporting implement according to the present invention;

FIG. 2 illustrates a plurality of different lattice structure types used in the manufacture of the sporting implement according to the present invention;

FIG. 3 is a perspective view of an end portion of the player hockey stick according to one embodiment of the sporting implement;

FIG. 4 is a sectional view of the shaft of the hockey stick according to one embodiment of the sporting implement;

FIG. 5 is a sectional view of the shaft of the hockey stick according to a further embodiment of the sporting implement;

FIG. 6 is a perspective view of an end portion of the player hockey stick according to another embodiment of the sporting implement;

FIG. 7 is a perspective view of an inner surface of the boundary wall of the hockey stick according to FIG. 6;

FIG. 8 is a perspective view of an end portion of the player hockey stick according to another embodiment of the sporting implement;

FIG. 9 is a perspective view of the stiffener flanges provided within the interior of the shaft of the player hockey stick according to another embodiment of the sporting implement;

FIG. 10 is a plan view of the stiffener flanges according to FIG. 9;

FIG. 11 is a plan view of a boundary wall of the shaft of the player hockey stick according to another embodiment of the sporting implement;

FIG. 12 is a schematic representation of the boundary wall according to the embodiment of FIG. 11;

FIG. 13 is a perspective view of the blade of the player hockey stick according to another embodiment of the sporting implement;

FIG. 14 is a perspective view of the blade of the player hockey stick according to another embodiment of the sporting implement;

FIG. 15 is a plan view of formed on the exterior surface of the blade of the hockey stick according to another embodiment of the sporting implement;

FIG. 16 is a schematic representation of a variation of the exterior surface of the blade of the hockey stick according to FIG. 15;

FIG. 17 is a plan view of an alternative texture provided on the blade or the shaft of the hockey stick according to another embodiment of the sporting implement;

FIG. 18 is a perspective view of 3D printed grooves forming indicia on the shaft of the hockey stick according to another embodiment of the sporting implement;

FIG. 19 is a perspective view of a joiner member for joining adjacent 3D printed structures to form the hockey stick according to another embodiment of the sporting implement;

FIG. 20 is an elevational view of a blade holder for mounting a blade onto a skate boot of a hockey skate;

FIG. 21 is a perspective view of the rear pedestal of a second embodiment of the blade holder;

FIG. 22 is an enlarged view of the rear pedestal according to the embodiment of FIG. 21;

FIG. 23 is a top plan view of the blade holder according to the embodiment of FIG. 21;

FIG. 24 is a front elevational view of a goalie mask according to the present invention;

FIG. 25 is a side elevational view of the goalie mask according to FIG. 24;

FIG. 26 is a perspective view of a further embodiment of the hockey stick;

FIG. 27 is an enlarged perspective view of a junction between the kick zone and the intermediate portion of the shaft of the hockey stick according to the embodiment of FIG. 26;

FIG. 28 is a schematic representation of a first portion of the shaft showing a first helix angle of the reinforcement strip of the hockey stick according to the embodiment of FIG. 26;

FIG. 29 is a schematic representation of a second portion of the shaft showing a second helix angle of the reinforcement strip of the hockey stick according to the embodiment of FIG. 26;

FIG. 30 is an enlarged view of a portion of the channel receiving the reinforcement strip at the upper or handle portion of the shaft and at the lower portion of the blade of the hockey stick according to the embodiment of FIG. 26;

FIG. 31 is an enlarged view of a portion of the channel receiving the reinforcement strip at the lower portion or kick zone of the shaft and at the upper portion of the blade of the hockey stick according to the embodiment of FIG. 26;

FIG. 32 is an enlarged view of a portion of the channel receiving the reinforcement strip at an intermediate portion of the shaft of the hockey stick according to the embodiment of FIG. 26;

FIG. 33 is a perspective view of the placement of reinforcement members representing a logo being mounted onto the lower portion or kick zone of the shaft of the hockey stick according to the embodiment of FIG. 26;

FIG. 34 is a sectional view of a further embodiment of a hockey stick in which adjacent sections of the shaft are joined at a junction with welding;

FIG. 35 is a sectional view of another embodiment of a hockey stick in which adjacent sections of the shaft are joined at a junction with welding;

FIG. 36 is a sectional view of yet another embodiment of a hockey stick in which adjacent sections of the shaft are joined at a junction with welding;

FIG. 37 is a schematic representation of a lattice frame of the shaft of a sporting implement having a lattice feature which varies along one axis gradually along a gradient portion of the shaft;

FIG. 38 is a schematic representation of a further embodiment of the lattice frame of the shaft of a sporting implement having a lattice feature which varies along multiple axes gradually along a gradient portion of the shaft;

FIG. 39 is a front elevational view of a lower portion of a hockey stick according to a further embodiment of the present invention;

FIG. 40 is a sectional view along the line 40 -40 in FIG. 39;

FIG. 41 is an exploded perspective view of a portion of the blade of the hockey stick according to the embodiment of FIG. 39;

FIGS. 42A and 42B are perspective views of the sporting implement of the present invention according to different embodiments of a baseball bat;

FIGS. 43A and 43B are perspective views of the sporting implement of the present invention according to different embodiments of a ski pole; and

FIG. 44 is a perspective view of the sporting implement of the present invention according to one embodiment of a cricket bat.

In the drawings like characters of reference indicate corresponding parts in the different figures.

### DETAILED DESCRIPTION

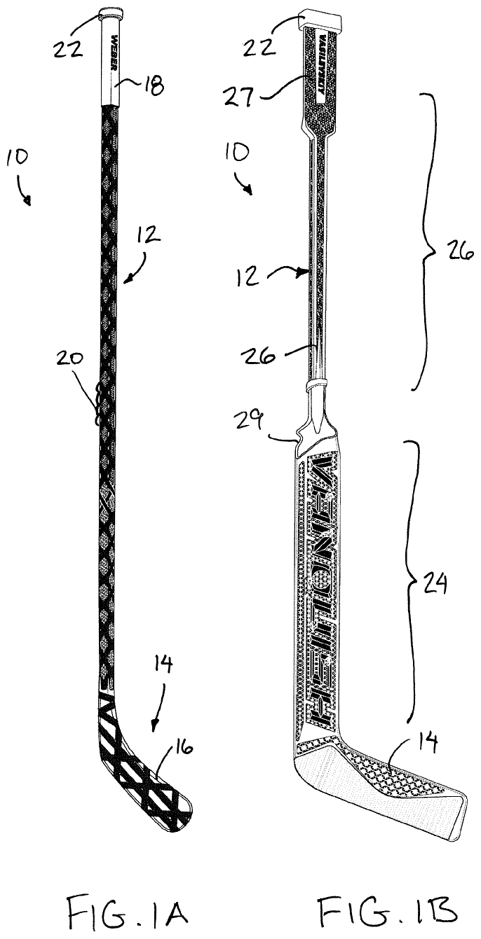

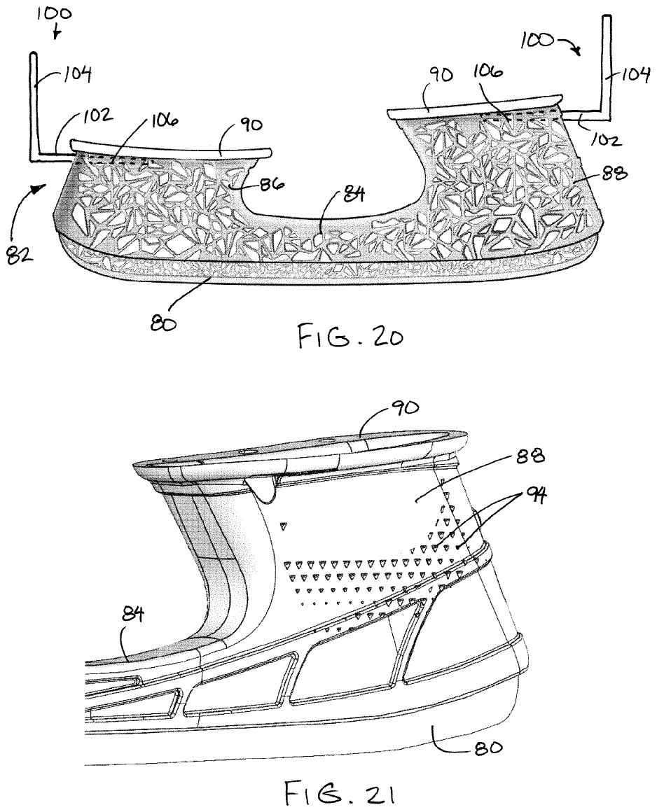

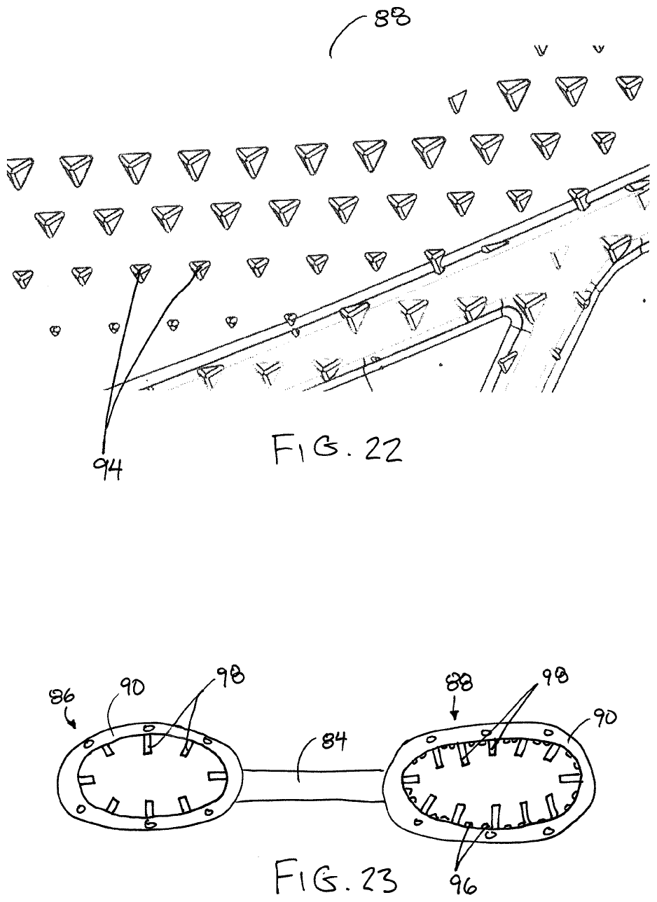

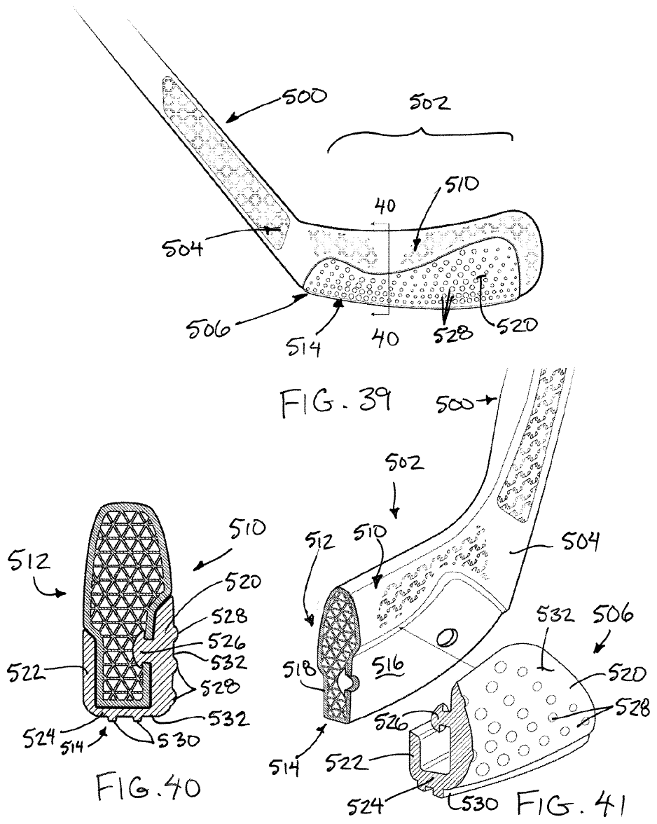

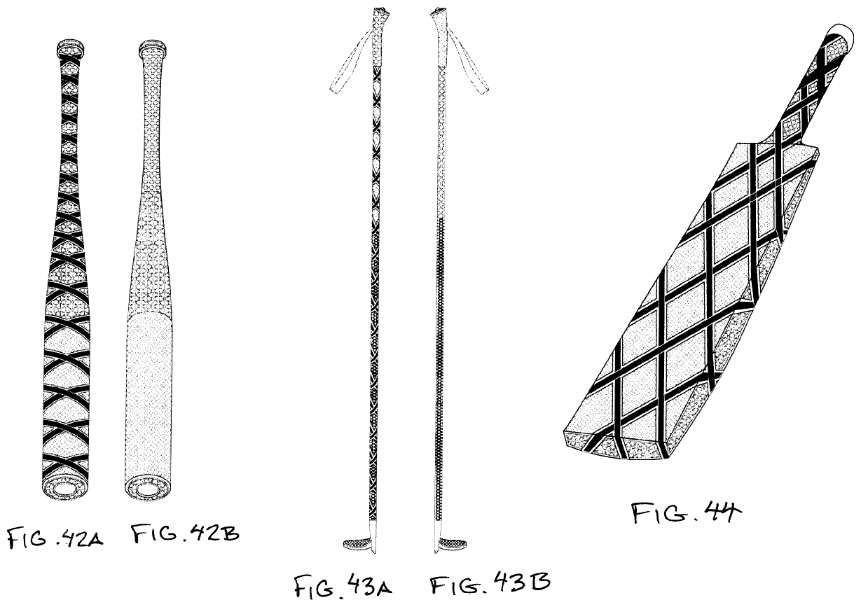

Referring to the accompanying figures there are illustrated various embodiments of a sporting implement. In each instance, the sporting implement is used for playing a sport, in which the sporting implement has a frame assembly defining a structural frame of the sporting element that is formed by a customizable 3-dimensional printed structure. For example, the sporting implement may comprise a hockey stick according to FIGS. 1 through 19, a component of a hockey skate according to FIGS. 20 through 23, or a protective hockey goalie mask according to FIG. 24 or 25. In yet further embodiments, the sporting implement may comprise any sporting implement with a shaft for gripping and a sporting tool at one end of the shaft such as a baseball bat according to FIG. 42A or 42B or a ski pole according to FIG. 43A or 43B. In order to manufacture the sporting implement, 3-dimensional printing instructions can be modified by initially receiving one or more user selections relating to the configuration of the sporting implement, followed by printing the 3-dimensional printed structure according to the modified 3-dimensional printing instructions using a 3-dimensional printer.

Turning initially to FIGS. 1 through 19, the hockey stick 10 generally comprises a shaft 12 extending longitudinally between a bottom end connected to a blade 14 and an opposing top end. The blade 14 is typically curved in profile between a heel end joined to the shaft 12 and an opposing toe end of the blade. The inside of the curve comprises a front face of the blade while the opposing outside of the curve defines the opposing rear face of the blade.

In the illustrated embodiment according to FIG. 1A, the hockey stick is a player stick in which the shaft includes integral protrusions formed at the top end of the shaft to define a top grip 18 as well as integral protrusions formed at an intermediate location partway between the top and bottom ends of the shaft to define an intermediate grip 20 as described in further detail below. The top end of the shaft may be further provided with an enlarged knob 22 that forms part of the top grip 18. The entirety of the hockey stick in this instance including the grips is formed by the 3D printed structure according to the present invention.

In the illustrated embodiment according to FIG. 1B, the hockey stick is a goalie stick in which the shaft 12 includes a lower paddle portion 24 joined at the bottom end to the blade 14, and an upper grip portion 26 extending upwardly from the lower paddle portion 24 to the top end of the shaft. The lower paddle portion 24 has an increased lateral width between opposing side edges so as to be comparable in dimension to the height of the blade 14, while the upper grip portion 26 is reduced in lateral width relative to the lower paddle portion 24 to be more suitable for gripping in the hand of a user. The shaft may include integral protrusions and/or recess defining an ergonomic handle grip 29 formed on the shaft between the lower paddle portion 24 and the upper grip portion 26 so as to be located directly above the lower paddle portion 24 so as to define an intermediate grip similarly to the player stick. An enlarged knob 22 may also be formed at the top end of the upper grip portion forming the top end of the shaft similarly to the player stick. The goalie stick may also be formed with an upper paddle portion 27 in which a width of the stick is increased above the upper grip portion 26 so as to define a generally flat plate-like body adjacent to the knob and lying generally within a substantially common plane with the lower paddle portion 24. Again, the entirety of the hockey stick including the grips is formed by the 3D printed structure according to the present invention.

The 3D printed structure can take many forms as described in the following. In some instances, the entire structure of the sporting implement 10 may be formed as a 3D printed structure which defines both the exterior boundary surfaces of the implement and the interior structure connecting between the exterior boundary surfaces. Interior volumes that are 3D printed, comprise a lattice structure including a plurality of nodes 28 spaced apart from one another in three dimensions together with a plurality of struts 30 interconnected between the nodes so that the struts extend transversely to one another in three dimensions.

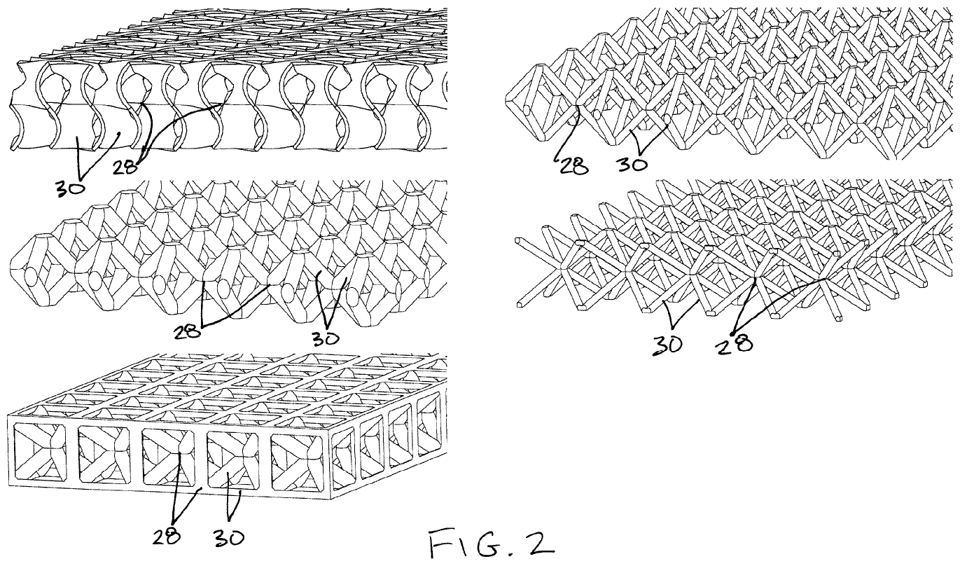

According to the embodiment of FIG. 5, the entirety of the structure of the hockey stick forming the shaft and the blade is formed of a lattice structure that is formed by 3D printing so as to define the outer boundary surfaces in addition to occupying the volume of the interior of the overall structure of the stick. The particular repeating pattern of the struts and nodes that form the interior volume of the stick can include a variety of different patterns that differ in density relative to one another so as to differ in performance characteristics such as overall strength including flexibility and bending strength to resist deflection from the longitudinal axis of the shaft. Various examples of different lattice patterns are illustrated in FIG. 2. Among possible lattice patterns for use in the various lattice structures or lattice frames described herein, a gyroid lattice structure is preferred.

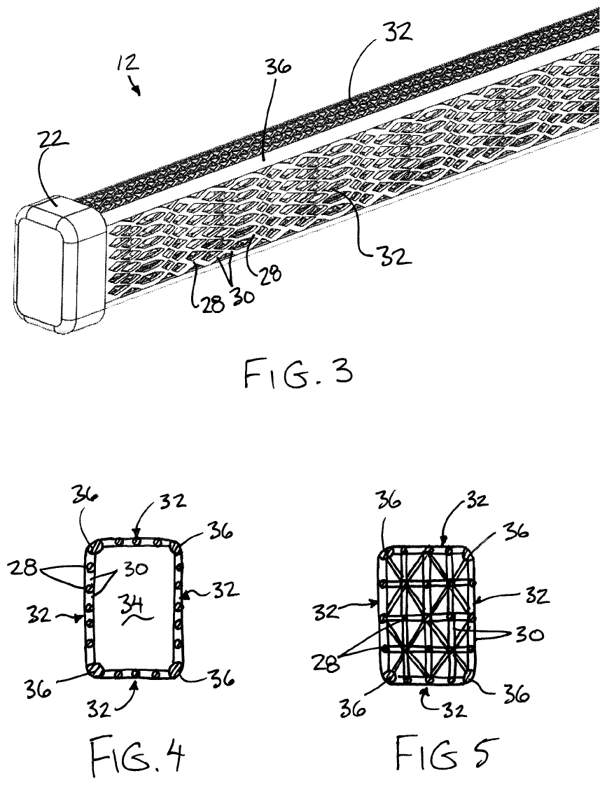

Alternatively, as shown in FIGS. 3 and 4, a 3D printed lattice structure may be used to construct the boundary walls 32 of the shaft such that the shaft comprises (i) an outer tube having a generally rectangular cross-section defining four corner edges extending along the length of the shaft between the top and bottom ends thereof, and (ii) a hollow interior 34 extending along a length of the shaft so as to be surrounded by the boundary walls 32. Each of the four boundary walls of the rectangular cross-section comprises a generally two-dimensional planar array of nodes 28 interconnected by struts 30 that extend transversely to one another. As in the previous embodiment, the density of the lattice structure, and the particular pattern of struts may vary along the length of the shaft to create different regions having different flexibility or bending strength relative to one another. The struts 30 forming the lattice are preferably connected between respective nodes in a continuous manner along each of the four corners to form a continuous corner member 36 extending the full length of the shaft at each of the four corners. The continuous interconnection of struts along each corner allows a hand of the user to more readily slide along the shaft during use.

Turning now to FIG. 6, according to a further embodiment, the 3D printed structure forming the stick may again form boundary walls 32 form in order to surrounding a hollow interior 34 extending along the length of the shaft. In this instance structural openings 38 are formed by the 3D printing process in a repeating grid or array pattern within each of the boundary walls 32. The structural openings 38 communicates through from the exterior surface of the boundary walls to the inner surface surrounding the hollow interior 34. The structural openings 38 comprise apertures that are placed to maximize strength or to introduce more flexibility at desired locations along the length of the shaft by varying the density of the openings at different longitudinal positions along the shaft.

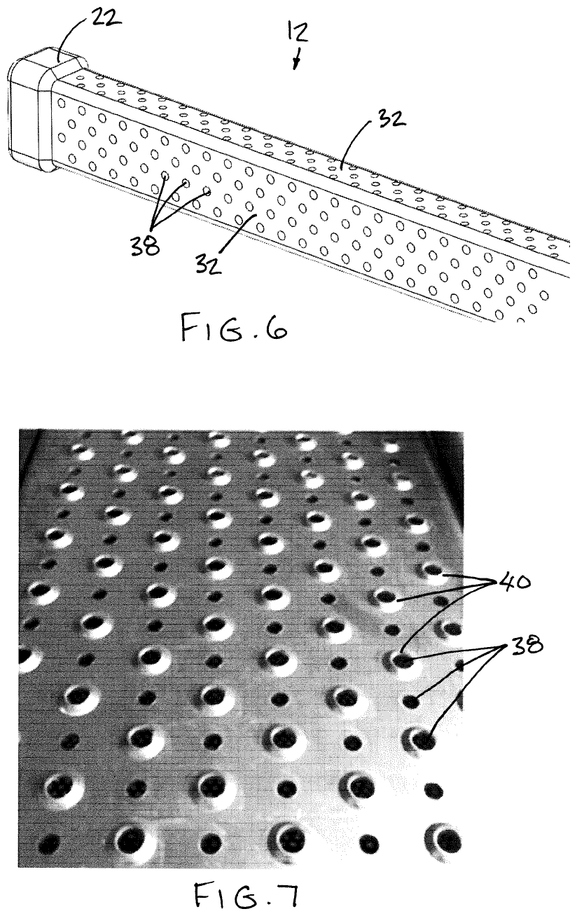

As shown in FIG. 7, the interior surface of each boundary wall may be further provided with stiffener flanges 40 which are associated with respective ones of the structural openings 38 so that each stiffener flange is round or annular in shape at the perimeter edge of the respective structural openings to protrude inwardly into the hollow interior of the shaft from the interior surface of the respective boundary wall. The stiffener flanges 40 protrude only partway across the hollow interior towards the opposing boundary wall. The flanges 40 can vary in shape, thickness, radial length, or other dimensions to vary stiffness or flexibility along the length of the shaft

According to a further embodiment shown in FIG. 8, the 3D printed structure may again comprise boundary walls 32 forming an outer tube surrounding a hollow interior to extend along the length of the shaft, however, in this instance a plurality of dimples 42 may be formed in a repeating grid or array on each boundary wall. At each dimple location 42 the material forming the boundary wall is deflected inwardly to form a recessed pocket that is recessed relative to the surrounding boundary walls at the exterior side while simultaneously forming a protrusion that protrudes inwardly from the inner surface of the boundary wall at the interior of the shaft. The dimples 42 form part of the 3D printed structure and provide a shape that also affects the strength and bending characteristics of the shaft such that the density of the dimples 42 can be varied along the length of the shaft to vary the structural properties of the shaft at different regions along the length thereof.

The dimples 42 may be further provided in combination with stiffener flanges 44 of the type shown in FIG. 8. The stiffener flanges 44 in this instance extend longitudinally along the full length of the shaft and protrude perpendicularly inwardly from the inner surface of each boundary wall to extend only partway across the hollow interior of the shaft. The depth that the stiffener flanges 44 protrude from the boundary walls can vary along the length of the shaft to again vary the strength and bending characteristics of the shaft. In the illustrated embodiment the stiffener flanges protrude less than half of the overall dimension across the shaft. The stiffener flanges are located between the dimples 42. Optionally additional dimples 42 may be formed in the stiffener flanges 44 as well to vary the strength characteristics of the flanges.

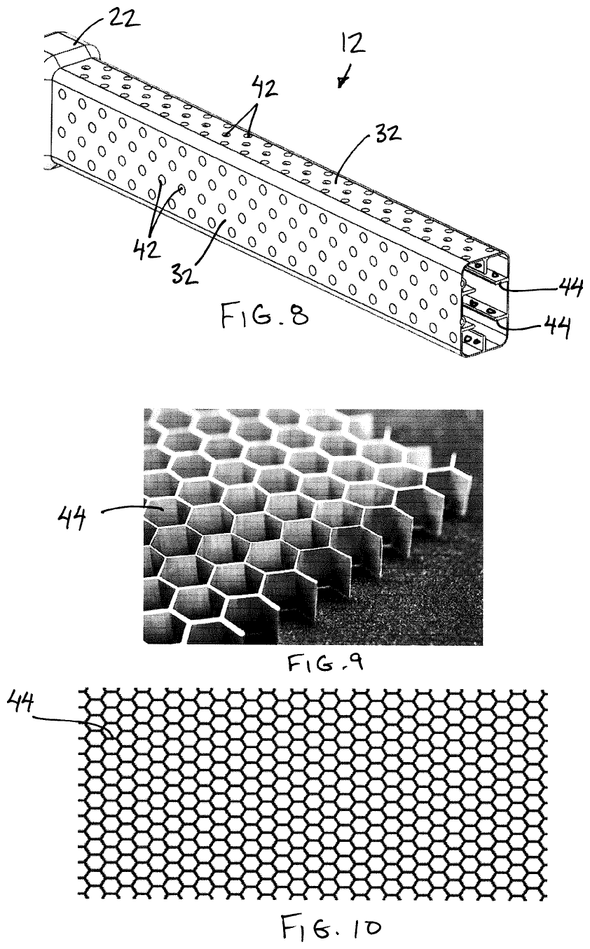

According to a further embodiment shown in FIGS. 9 and 10, the stiffener flanges 44 may be arranged in a repeating array pattern such as a polygon grid of repeating polygonal shapes including hexagonal cells as illustrated, or triangular or rectangular cells in further embodiments. Preferably some of the flanges are oriented transverse to the longitudinal direction of the shaft. When the stiffener flanges form a repeating array pattern according to FIGS. 9 and 10, the stiffener flanges 44 remain supported on the boundary walls 32 to protrude inwardly from the interior surface thereof so that the stiffener flanges again extend only partway across the corresponding dimension of the shaft.

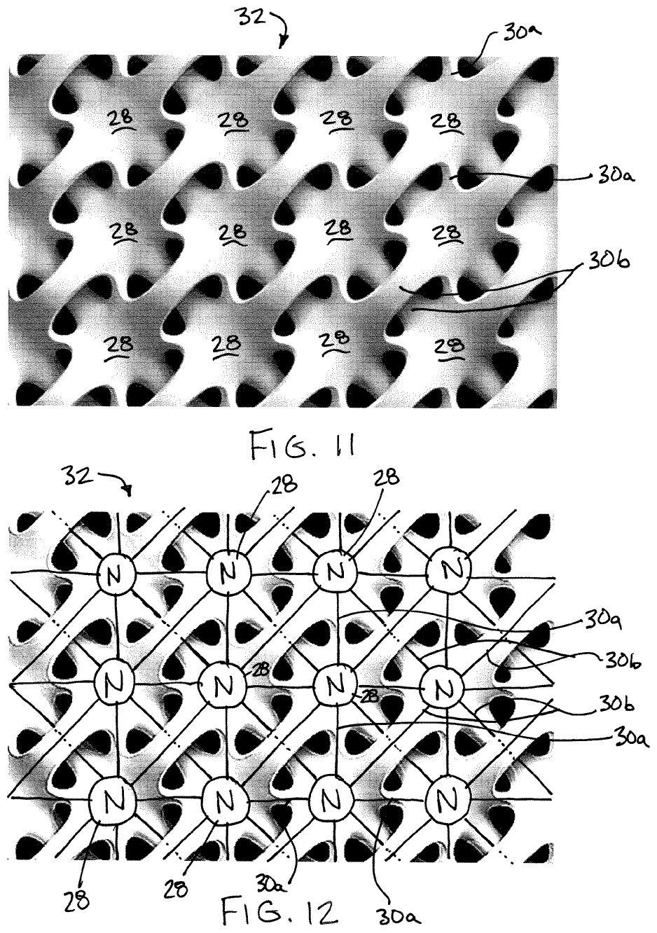

Turning now to the embodiment of FIGS. 11 and 12, the 3D printed structure again defines boundary walls of a hollow shaft in which each of the boundary walls comprises a printed lattice structure forming a two-dimensional array of nodes 28 interconnected by struts 30. According to the illustrated example, the nodes are arranged in a rectangular or Cartesian grid in which the nodes are spaced apart along first axes and second axes that are perpendicular to one another.

Each node 28 is thus positioned to be adjacent four other nodes along the rectangular grid corresponding to north, south, west and east directions of the Cartesian grid. Each node 28 is directly connected to these four rectangularly adjacent nodes by Cartesian struts 30a which extend along the first and second axes of the two dimensional array. In the illustrated embodiment, each Cartesian strut 30a is a band of material having a width between side edges that is greater than the thickness thereof in which the band is twisted about a longitudinal axis through 180 degrees as it extends between the connected nodes 28.

Each node 28 is further adjacent to four additional nodes along diagonal axes of the Cartesian grid corresponding to northwest, northeast, southeast, and southwest directions. In the illustrated embodiment, each node 28 is connected to these four diagonally adjacent nodes by four diagonal struts 30b axes of the two dimensional array. The diagonal struts also comprise a band of material having a width between side edges that is greater than the thickness thereof while being wider than the Cartesian struts described above. Each diagonal strut 30b extends between a respective pair of nodes 28 to extend across in a perpendicular and overlapping configuration with another one of the diagonal struts 30b that is connected between a different respective pair of nodes 28 of the array. Each diagonal strut 30b and the corresponding diagonal strut 30b that overlaps across it form a pair of overlapping struts having no direct connection therebetween such that the overlapping struts remain freely movable relative to one another except as constrained by the interconnection of the struts through other nodes and struts.

The diagonal struts of each overlapping pair of struts may be in direct contact with one another in an un-deflected, neutral position of the hockey stick; however, in other embodiments the diagonal struts of each overlapping pair of struts may remain spaced apart from one another by a gap between the struts which extends in a direction perpendicular to the two-dimensional array of the nodes. When flexing the shaft, the gaps between the diagonal struts of each overlapping pair may close such that the abutment of the overlapping struts functions as a stop to limit further deflection. Accordingly, the flexibility of the stick and the amount of deflection permitted can be controlled to some degree by controlling the gap between overlapping pairs of struts in the arrays of FIGS. 11 and 12 in addition to controlling the rigidity and flexibility of the material forming the lattice structure. The 3D printing instructions can be modified to provide different gaps at different locations to customize the flexibility profile along the length of the shaft to the selections of the user.

In further embodiments, the performance characteristics of any of the lattice patterns described herein may be varied by changing the diameter or thickness of the struts connected between nodes to affect the density of the lattice.

In each of the embodiments described above, the blade is typically formed continuously with part or the entirety of the shaft as a common 3D printed object. The blade may be formed similarly to the shaft so as to be comprised of various lattice structures which may both (i) define the exterior boundary surfaces of the blade and (ii) occupy a portion of the volume of the interior of the blade between opposing boundary surfaces.

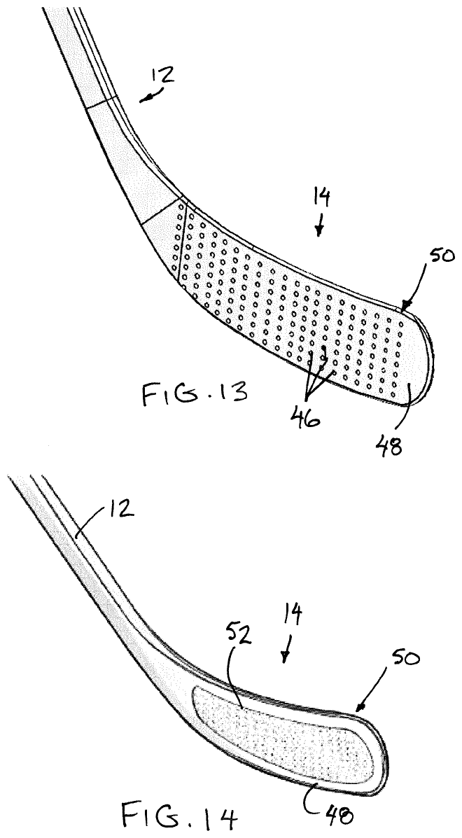

According to one embodiment shown in FIG. 13, the blade may comprise a solid mass of material which is 3D printed to include a plurality of structural openings 46 therein so that the overall blade structure is perforated. The structural openings 46 are shown spaced apart from one another in a grid pattern and are formed together with the structure of the blade as a 3D printed structure. The structural openings 46 extend fully through the blade from the front face 48 of the blade to the rear face 50 of the blade. The structural openings 46 may be provided in a regular pattern through the entire structure of the blade between heel and toe ends of the blade, or the perforated openings may be located at greater density within specific regions of the blade to vary the stiffness of the blade along the length thereof between heel and toe ends as may be desired.

The blade or shaft of the stick may be further modified to include a textured surface 52. The textured surface may occupy the entirety of the exterior surface of the blade or stick, or may be contained within a bounded region as shown in FIG. 14. In this instance the textured surface 52 occupies only a portion of the overall height and overall length of the blade. The textured region 52 may also be located closer to the toe end or closer to the heel end of the blade or at specified locations along the shaft according to user preference.

As shown in FIG. 15, the texture on the exterior surfaces of the blade may be formed by a plurality of protruding members 54 which each protrude perpendicularly outward from the exterior surface or outer boundary surface of the blade. The protruding members 54 are preferably arranged in a repeating array pattern. In the illustrated embodiment each protruding member is dome shaped so as to be approximately semi-spherical in shape while locating a socket 56 centrally therein. In this instance, the socket is triangular in shape and defines a perimeter edge about the socket where the exterior surface of the dome and a corresponding interior surface of the socket intersect one another at an acute angle forming a sharpened perimeter edge of the socket that enhances grip on the resulting surface of the blade.

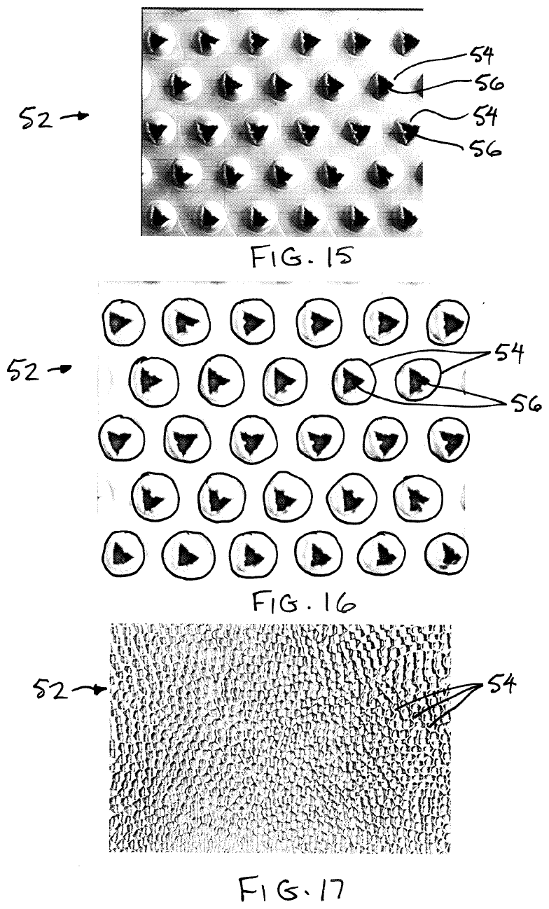

The protrusions and corresponding sockets may vary in shape including round, triangular or other shapes of protruding members tapering outwardly towards a respective apex that may or may not include an additional socket to increase the amount of edges providing frictional grip. The protruding members 54 and the corresponding sockets 56 can also vary in size relative to the blade according to FIG. 16. The protruding members 54 can also be provided as irregular shapes located in close proximity to one another in an irregular pattern according to FIG. 17 while still providing increased friction and grip to enhance performance of the blade gripping a puck or of the hands of the user gripping the shaft during use in the game of hockey.

In each instance, any protruding members or recessed grooves that are recessed into the interior from the exterior boundary surfaces of the blade, are formed together with the shaft and blade as part of the three-dimensional printed structure formed by 3D printing.

In yet further embodiments, a lattice structure formed by the 3D printing process to define the printed structure of the blade may include open front and rear faces of the blade where the three-dimensional lattice structure remains exposed such that the nodes and struts of the lattice structure forming the boundary surfaces of the blade provide sufficient interrupted edges and grooves between struts to enhance the grip over solid body blade structures of the prior art.

As shown in FIG. 18, the shaft of the stick may also be provided with recessed grooves 58 which are recessed inwardly relative to the surrounding boundary surface of the exterior of the shaft. The grooves 58 may be provided in an irregular pattern at the desired intermediate and top grip locations of the shaft for grip.

The grooves 58 may also be arranged in a prescribed pattern to define numbers, letters or logos as identifiable indicia for communicating information such as a player name, a player number, or branding information and the like according to FIG. 18.

Alternatively, the shaft of the stick may also be provided with protruding members (not shown) which protrude outwardly relative to the surrounding boundary surface of the exterior of the shaft in a regular or irregular pattern to provide additional grip at the desired intermediate and top grip locations of the shaft.

In some instances, the shaft 12 of the hockey stick may be formed in a plurality of sections such that the printed structure forming the hockey stick includes a first structure 60 comprising a first shaft section integrally supporting the blade thereon and a second printed structure 62 comprising a second shaft section arranged to be mounted end-to-end with the first shaft section of the first structure 60. Depending on limitations to the overall length of object that can be printed by a particular 3D printing manufacturing process, the shaft may be formed in yet further shaft sections as required. Each of the adjacent shaft sections that are to be interconnected for forming the overall shaft of the hockey stick is preferably provided with a mating connector integrally printed at one end thereof for joining by mating connection to the end of the adjacent shaft section.

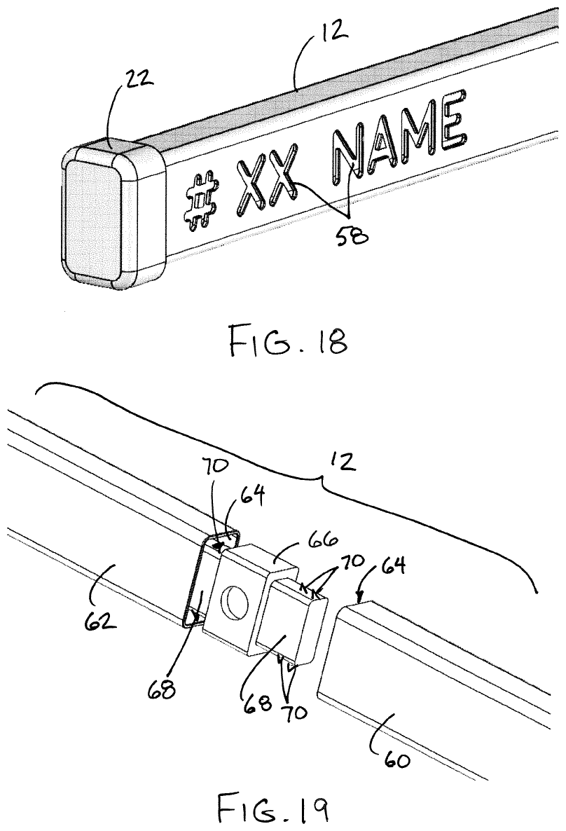

In the illustrated embodiment the ends of two shaft sections are joined by providing a female socket 64 at the end of each shaft section. In this instance, an additional joiner member 66 is provided which defines two opposing male ends 68 which mate with the female sockets 64 respectively. When the joiner member 66 is mated with a first one of the shaft sections, the joiner effectively forms a male connector protruding from the first one of the shaft sections. In alternative arrangements, one of the shaft sections may be simply formed with the male connector 3D printed directly thereon. As shown in FIG. 19, the male connectors may be provided with ratchet members 70 integrally formed thereon having a first ramped face to guide insertion of the ratchet members into the corresponding socket and an opposing perpendicular face that acts as a stop to engage corresponding surfaces within the socket of the stick section mated thereto. In this manner the ratchet members 70 allow ready insertion of the male connectors into corresponding female connectors, while preventing removal and separation thereof.

Optionally additional adhesive may be used between the mating surfaces of the connectors to prevent removal.

In yet further embodiments, the male connector may comprise an externally threaded protrusion that mates with corresponding internal threads within the socket so that the male connector is screwed into the female sockets for assembly. In this instance, ratchet members 70 may again be provided along the threads so as to be oriented in a suitable orientation so as to allow ready insertion of the male connector into the female connector while again restricting removal.

All of the structures described above with regard to the hockey stick are preferably prescribed before manufacturing using 3D printing instructions that are modified according to user preference. A suitable computer interface is provided through which a user can select any number of configuration variables. Once the manufacturing system receives the user selections regarding the configuration of the hockey stick, the printing instructions can be further modified to accommodate the user selections, followed by manufacturing of the hockey stick in a single 3D printing operation that dictates the shape and structure of all the configured details of the hockey stick. Configurations which can be customized may include the blade curve profile, the blade shape including a square or rounded toe end, blade length, blade texture, blade angle relative to the shaft, blade density and/or flexibility, the lattice type and density forming the blade structure, the shaft profile including the cross-sectional shape, shaft grip or texture configuration and location along the shaft, shaft length, grip configuration, density and/or flexibility, lattice type forming the structure of the shaft, indicia on the shaft in the form of grooves or raised protrusions, and material selection including metal such as titanium or composite materials including para-aramid fibers or other fiber and resin matrix combinations.

Turning now to FIGS. 20 through 23, the 3D printed structure in this instance is configured so that the sporting implement defines a blade holder of a skate. The blade holder is arranged for mounting on to the bottom surface of a skate boot for supporting a skate blade relative to the skate boot. The blade holder 10 includes an upper boot mounting portion 82 arranged to be mounted onto the skate boot and a lower blade mounting portion 84 which integrally supports the skate blade 80 thereon. In the illustrated embodiment, the upper boot mounting portion 82, the lower blade mounting portion 84 and the integral skate blade 80 comprise a uniform 3D printed structure formed of a common material, preferably titanium. The skate blade 80 in this instance is manufactured to have a standard lateral width comparable to conventional hockey skates, while extending the full length of the blade holder.

The lower blade mounting portion 84 extends continuously along the top of the blade 80 while being enlarged in lateral width compared to the blade 80 for increased strength. The upper boot mounting portion 84 includes a front pedestal 86 and a rear pedestal 88 which form columns extending upwardly from the lower blade mounting portion at longitudinally spaced positions towards front and rear ends of the blade to be joined to the skate boot at the top ends thereof at longitudinally spaced positions adjacent to the toe end and heel end of the skate boot respectively. At the top end of each pedestal 86 and 88, a flange 90 protrudes radially from the pedestal with fastener holes formed therein for fastening the pedestal to the bottom side of the skate boot.

According to the embodiment of FIG. 20, the entire structure of the blade 80, upper boot mounting portion 82, and lower blade mounting portion 84 are formed as a single 3D printed structure formed of a common material throughout. More particularly, the entirety of the blade holder 10 is formed of a lattice structure having nodes spaced apart from one another in three dimensions with the lattice structure defining the exterior boundary surfaces of the skate holder. The blade in this instance includes (i) an upper portion 80a also formed as a lattice structure open to the exterior boundary walls at opposing sides of the blade along the full length of the blade and (ii) a lower portion 80b formed as a solid material along the full length and width to form the skating edge of the blade at the bottom thereof.

According to the embodiment of FIGS. 21 through 23, the blade holder 10 is again formed entirely as a 3D printed structure including the blade 80 integrally formed thereon, however each of the pedestals 86 and 88 in this instance instead comprises a tubular boundary wall 92 forming a hollow tube supporting the radial flange 90 at the top end thereof. A plurality of structural openings 94 communicate through the tubular boundary wall 92 from the exterior surface to the hollow interior of the pedestal. The structural openings 94 are formed as part of the 3D printed structure so as to be configured in a regular repeating array pattern. The size and density of the structural openings 94 can be configured to optimally reduce weight while maximizing strength of the tubular boundary wall 92.

To further improve the strength of the tubular boundary wall 92, annular stiffener flanges 96 may be associated with some or all of the structural openings 94 in which each annular stiffener flange 96 extends about the perimeter of a respective opening to protrude inwardly from the inner surface of the tubular boundary wall similarly to the stiffener flanges on the interior surfaces of the shaft of the hockey stick according to FIG. 7. Additional stiffener flanges 98 may be mounted on the inner surface of the tubular boundary wall 92 to protrude radially inwardly from the inner surface of the tubular boundary wall at circumferentially spaced positions to extend only partway across the hollow interior similarly to the stiffener flanges on the interior of the hockey stick described earlier. The stiffener flanges 98 may span the majority of the height of the pedestals. The thickness and density of stiffener flanges may be varied according to the performance requirements.

Each embodiment of the skate holder may be further configured to cooperate with an alignment tool 100 shown schematically in FIG. 20. The tool 100 includes a mounting member 102 which is elongate along a first axis and a guide member 104 which is elongate along a second axis oriented perpendicularly to the first axis in which the mounting member 102 and the guide member 104 are joined at respective ends to one another to form an L shape. The mounting member has a continuous cross-sectional shape along the length thereof which is noncircular in shape for mating with a corresponding socket 106 which is 3D printed into both of the pedestals of the blade holder. The sockets 106 in the holder include a first socket in the front pedestal that is open at the toe end of the blade holder and a second socket in the rear pedestal that is open at the heel end of the blade holder. Each socket extends in the longitudinal direction of the skate blade so as to receive the mounting member inserted therein for relative sliding movement in the longitudinal direction by the mating profiles of the socket 106 and the mounting member 102. In the mating configuration of the mounting member received within a selected socket 106, the guide member 104 extends vertically upward from the outer end of the mounting member to be selectively abutted against the toe or heel end of the skate boot. The sockets 106 are laterally centred relative to the blade holder. Accordingly, locating the guide members 104 to be laterally centred relative to the toe and heal of the skate boot provides a visual guide that the blade holder 10 is laterally centred relative to the skate boot at both toe and heel ends of the skate boot. Once the blade holder has been mounted onto the skate boot, the alignment tools 100 can be removed from the blade holder.

Similarly to the previous embodiment, the manufacturing of the blade holder involves 3D printing of the entirety of the blade holder structure according to 3D printing instructions. Using a suitable computer interface, the user of the product initially selects various optional details relating to the configuration of the blade holder including the blade profile radius, the radius of the edge at the bottom of the skate blade, the fastener pattern for aligning with the fastener holes of the skate boot, the overall height of the blade relative to the skate boot, the height of the rear pedestal relative to the height of the front pedestal, the overall blade length, the spacing between the front and rear pedestals, the pattern of structural lattice or structural openings in the body of the blade holder and/or blade, and the material forming the entirety of the blade holder and blade respectively. Once the selections are received, the system modifies the 3D printing instructions according to the user selections and then the blade holder can be 3D printed according to the modified printing instructions.

In further embodiments of the blade holder, the skate blade 80 may be formed as a separate and replaceable component which is releasably mounted on the remainder of the skate blade holder.

Turning now to FIGS. 24 and 25, in this instance the sporting implement comprises a hockey goalie mask 110. The goalie mask 110 includes a main body portion 112 forming an exterior shell arranged to extend about a majority of the head of the user. More particularly, the main body portion extends over: the top of the head, the forehead, sides of the head including the ears and temporal regions, and the entirety of the jaw of the user. An additional rear shell section 13 cooperates with the main body portion to span over the rear of the head of the user so as to fully surround the head of the user together with the main body portion.

The main body portion includes a central viewing portion 116 integrated therein in alignment with the eyes of the user. The viewing portion is defined by a plurality of viewing openings 118 in which some of the openings are partly bounded by the main body portion about the perimeter of the viewing portion 116 while some of the openings are partly or fully bounded by one or more bar members 120 spanning across the viewing portion between respective ones of the openings 118. The bars 120 collectively form a cage across the viewing portion in the main body portion 112 to protect the eyes from any impacts from a puck during the game of hockey.

The bar members 120 and the main body portion 112 are formed together as a continuous and seamless unitary body of material that is manufactured as a single 3D printed structure to be formed of the same material throughout by a 3D printing manufacturing process. In the preferred embodiment the main body portion 112 and the bars 120 are formed of the same metal, for example titanium.

The main body portion may comprise a three-dimensional lattice structure in which the lattice structure defines the entirety of the main body portion including the exterior and interior boundary surfaces of the shell of the goalie mask. In this instance the resulting lattice structure may remain open at the boundary surfaces between the struts and nodes of the lattice structure.

The manufacturing process of the hockey goalie mask again involves obtaining a plurality of user selections relating to the configuration of the sporting implement followed by modification of the printing instructions according to the user selections so that the goalie mask can be subsequently manufactured using a 3D printer following the modified printing instructions. The various user selections relating to the configuration of the goalie mask can include the number of viewing openings 118, the shape, size and location of the viewing openings, the number of bars 120, the shape, size and configuration of the bars 120, the shape of the main body portion 112, the size and ornamentation of the main body portion 112, and the choice of material forming the 3D printed structure including the main body portion and the bar members.

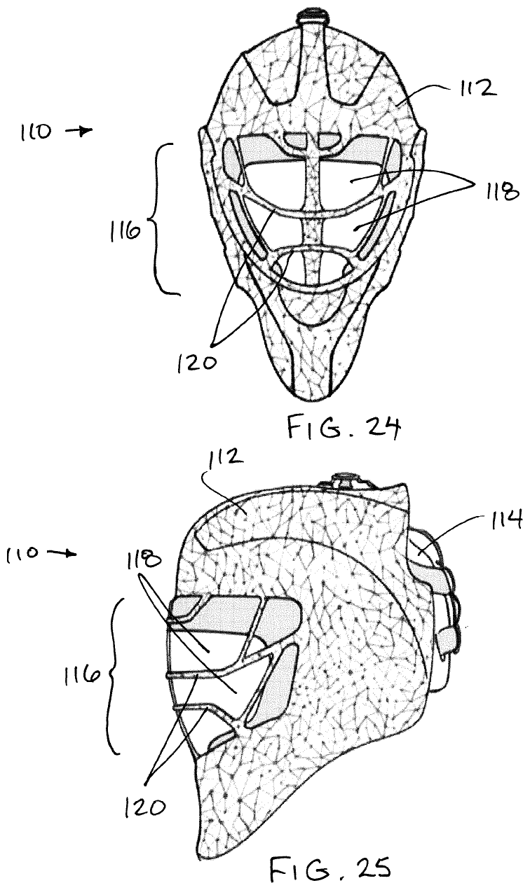

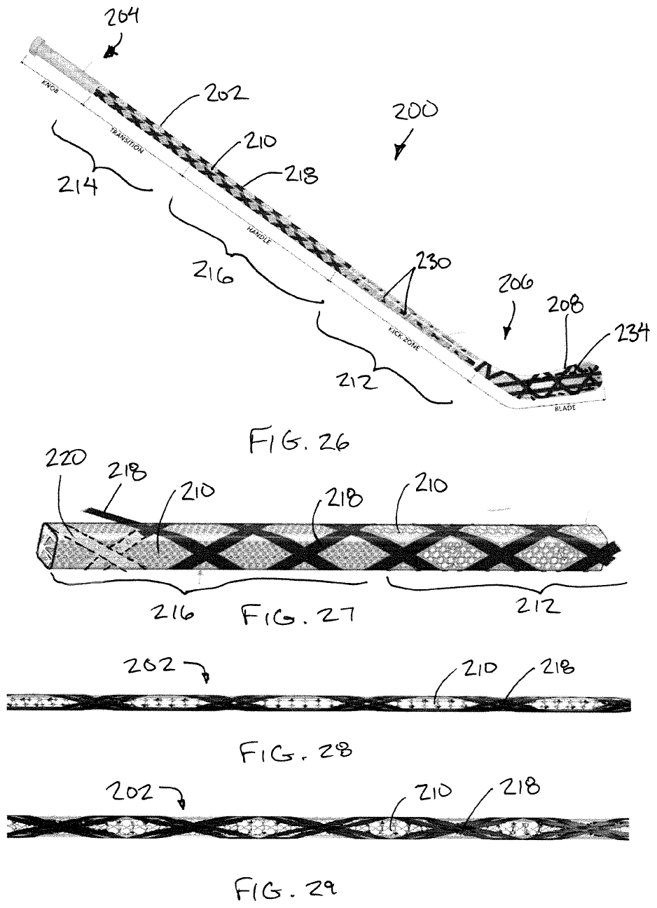

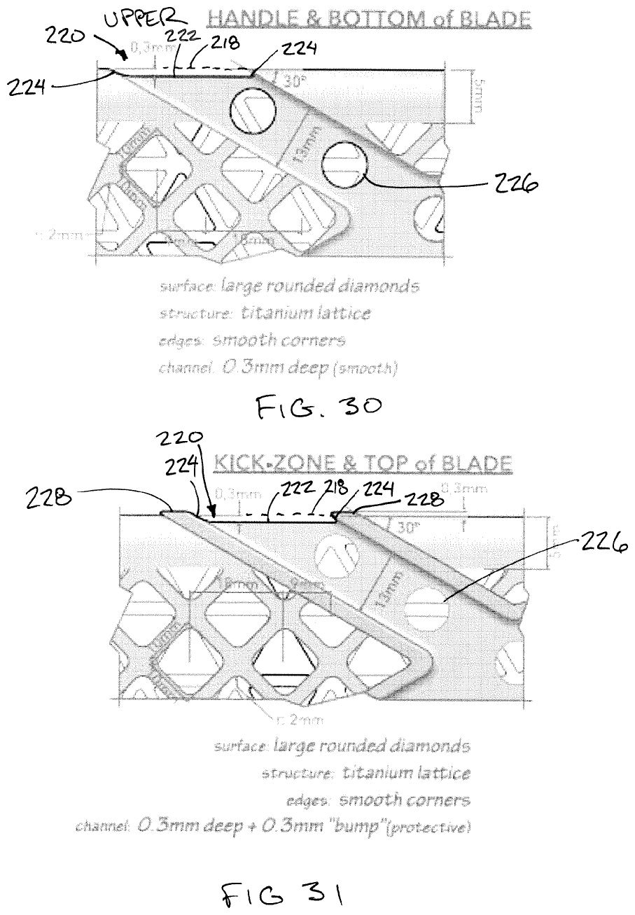

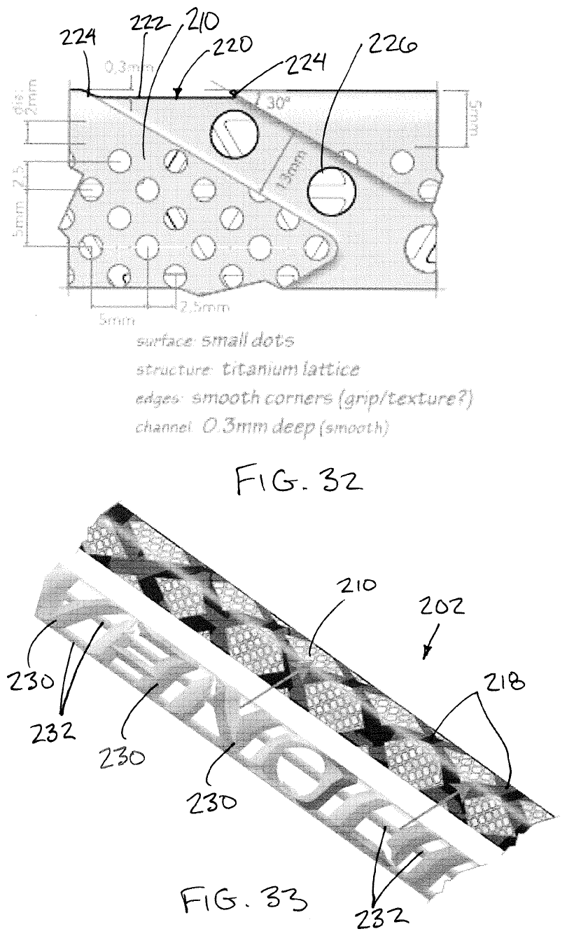

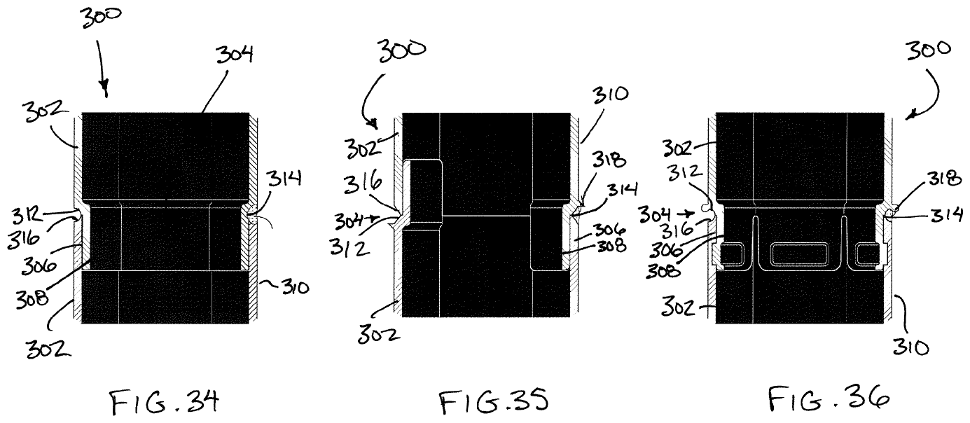

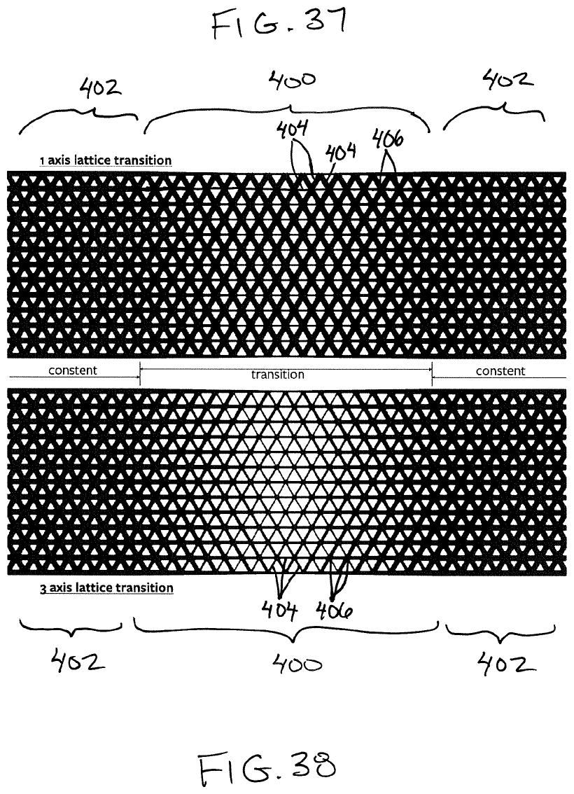

Turning now to FIGS. 26 to 33, a further embodiment of the hockey stick is designated by reference character 200. In this instance, the hockey stick includes a shaft 202 extending longitudinally between a top end 204 and a bottom end 206. A blade 208 extends outwardly from the bottom end of the shaft transversely to the longitudinal direction of the shaft. The shaft 202 and the blade 208 are formed similarly to one another such that each includes a core frame 210 formed by a customizable 3-dimensional printed lattice structure as described above, with an additional arrangement of reinforcement strips 218 wrapped about the core frame 210. Along the length of the shaft, the strips 218 preferably extend helically about the core in two opposing helical directions as shown; however, the strips 218 may also be wrapped in one helical direction, or wrapped circumferentially or longitudinally of the shaft or blade as required to achieve the desired performance characteristics.

The core frame 210 may be formed as a single structure spanning a full length of the shaft and the blade is a single unitary structure, or alternatively may be formed in two or more sections joined longitudinally end to end with one another in a row. The blade may be integral with a lowermost section of the shaft or may be formed as a separate section from the shaft. The separate sections of the shaft and blade can be joined to one another by various techniques as described above including adhesive bonding, mechanical coupling, welding, or any combination thereof. Each section can be printed as a 3-dimensional open lattice structure as described above with customizable variations to vary the lattice density, flexibility, cross-sectional shape, and the like as described above in the previous embodiments. In one example the cross-sectional shape may transition between a rectangular shape and an ovoid shape along different portions of the length of the shaft. For example, the knob mounting location at the upper portion of the shaft may be ovoid, while a remainder of the shaft is rectangular, or vice versa.

Each shaft is constructed with multiple zones which may have different properties relative to one another. A bottom third of the length of the shaft adjacent to the blade defines a lower portion 212 of the shaft also known as the kick zone where the shaft is most likely to be flexed to produce a spring-like rebounding effect when shooting a puck. At the opposing top end of the shaft, an upper third of the length of the shaft adjacent to the top end defines an upper portion 214 of the shaft also referred to as the grip portion where the shaft is most likely to be gripped by an upper hand of the user. A knob may be integrally formed in the upper section 214, or subsequently attached. An intermediate portion 216 of the shaft between the lower portion 212 and the upper portion 214 defines a central zone suitable for being gripped by the lower hand of the user.

Each of the defined zones can be formed with different properties relative to the adjacent zones to be best suited for the intended function of that zone. For example, the upper or grip portion of the shaft may be formed with exterior gripping texture or a knob formed integrally thereon as part of the lattice structure printed with the core 210. The exterior surfaces may be formed as an open lattice with large openings to minimize weight.

At the intermediate portion 216, the exterior surfaces may be formed with an open lattice having smaller openings compared to the upper portion above and the lower portion below to provide a smoother exterior surface for gripping with the lower hand of the user such that the lower hand can be easily slid along the shaft in use. The lower portion 212 may be formed at the exterior to maximize impact protection and strength while also imparting desirable resilience to provide a desired degree of deflection and resilience to return to shape once deflected according to the user preference. Some strength and impact protection can be provided by the exterior structures formed on the core 210 as described below and as well by the addition of externally applied members also described in further detail below.

The reinforcement strips 218 are formed of a composite fibre and resin material which are wrapped helically about a longitudinal axis of the shaft along a full length of the shaft and along the blade both longitudinally of the blade and helically about the blade. Each of the shaft and the blade includes two reinforcement strips 218 which are wrapped helically in opposing directions so as to repeatedly intersect one another along the length of the shaft or blade. The reinforcement strips 218 are wrapped about the exterior in the form of a flat band or ribbon of composite material that lays flat against the exterior surface of the shaft or blade. In preferred arrangements, the composite material comprises continuous filaments of carbon fibers which span the full length of the strip and accordingly a full length of the shaft and blade as a single integral member to maximize tensile strength. In a preferred embodiment, the filaments forming each reinforcement strip 218 are impregnated with resin prior to wrapping onto the core 210 such that a minimal amount of resin is required to bond the composite material to the core. However, in further embodiments the filaments could be woven with other fibers formed of a heat formable material such as a thermoplastic material so that after winding, the application of heat can be melted to bond with the lattice frame and the filaments to form the composite material. In yet further embodiments, resin can be applied subsequent to wrapping of the filaments about the lattice frame.

Typically, a series of channels 220 are recessed into the exterior surface so as to be at least partially recessed inwardly into the interior of the core relative to an exterior boundary of the core in each instance. The channels 220 define the intersecting helical paths along the outer surface of the core 210 that receive the reinforcement strips 218 therein. The channels are thus formed together with the core 210 when three dimensionally printing the open lattice structure of the shaft and blade. Each section of the channels 220 has a generally U shaped cross section having an innermost boundary 222 that is generally parallel to the corresponding exterior surface of the stick at a location recessed inwardly relative to the exterior boundary, and two longitudinally opposed boundaries 224 extending outwardly of the core 210 from longitudinally opposing ends of the innermost boundary 222 towards the exterior boundary. When taken in cross-section within a plane in a common direction of the longitudinal axis of the shaft, the longitudinally opposed boundaries 224 are sloped in a common direction relative to the longitudinal axis of the shaft, for example at an angle of approximately 30°, but which may be within a range of angles between 10° and 80° for example. In this instance, one of the boundaries 224 forms an acute angle with the innermost boundary 222 so as to be partially undercut to retain one edge of the respective reinforcement strip 218 received therein while the opposing boundary 224 meets the innermost boundary at a corresponding obtuse angle for guiding the reinforcement strip 218 longitudinally into the undercut area as the material is wrapped about the core 210.

The innermost boundary 222 is shown with openings 226 formed at spaced apart positions therein along the length of each channel in which the openings are formed as part of the open lattice structure that is three dimensionally printed. The holes partially receive some of the resin material impregnated on the reinforcement strips as the reinforcement strips are wrapped about the core 210 to improve bonding between the reinforcement strips 218 and the core as the resin is secured in place about the core 210. The fibre and resin material also fills the undercut areas along one of the boundaries 224 of each channel to also assist in retaining the reinforcement strips mechanically relative to the core 210 in addition to the bonding by the resin.

At the intermediate zone 216 shown in FIG. 32, the depth of the channel 220 relative to the exterior boundary of the core is approximately equal to a radial thickness of the reinforcement strip 218 such that when the reinforcement strip is received within the channel, the reinforcement strip is substantially flush with the exterior boundary of the core 210.

At the upper portion or grip portion shown in FIG. 30, the channel depth may be similarly configured to the intermediate portion 216 described above so that the reinforcement strip 218 is flush with the exterior boundary of the core 210. The lattice structure may be more open in this instance compared to the intermediate portion to reduce weight compared to the intermediate portion while maximizing smoothness of the exterior surface at the intermediate portion so as not to interfere with sliding of the lower hand along the intermediate portion of the shaft. The lower portion of the blade is configured similarly to the upper portion of the shaft shown in FIG. 30.

At the lower portion 212 or kick zone of the shaft, and similarly along the upper portion of the blade, a plurality of protruding ribs 228 are provided on the core frame to protrude outwardly relative to the remaining exterior boundary of the core. The protruding ribs 228 in the illustrated embodiment extend alongside both of the longitudinally opposed boundaries 224 to follow the helical shape of the channels 220 and the reinforcement strips 218 received therein. Each protruding rib 228 may be substantially flush at one side with the corresponding one of the boundaries 224 adjacent which the protruding rib is supported. The ribs 228 serve to increase the depth of the channels 220 at the location of the ribs. While maintaining the thickness of the reinforcement strips 218 constant along the length of the shaft, the reinforcement strips 218 are recessed inwardly into the core relative to the protruding ribs 228 at the location of the ribs along the lower portion 212 or kick zone. The reinforcement strips 218 in this instance may again be substantially level with the exterior boundary of the core along the kick zone, but due to the protruding nature of the ribs 228 the composite fiber and resin material is effectively recessed inwardly relative to the ribs to protect the composite material from impacts.

In further embodiments, the channels may be simply increased in depth at the lower portion or kick zone instead of providing additional protruding ribs to provide the same effect of recessing the composite material inwardly relative to the adjacent boundaries of the channel. In each instance of a deeper channel, the deeper portion of the channel may receive more layers or plies of the reinforcement strip over specific regions or zones of the shaft to improve performance.

As shown in FIGS. 28 and 29, a helix angle of the channels and of the reinforcement strips received therein can vary along different portions of the shaft and blade. This has the effect of varying the performance or physical properties of one zone of the shaft relative to another. Accordingly in preferred embodiments the lower portion 212 or kick zone of the shaft may be provided with channels and reinforcement strips 218 received within the channels having a different helix angle than a remaining portion of the shaft or blade for example.

Turning out to FIG. 33, a plurality of impact resistant members 230 are shown being mounted onto the lower portion 212 or kick zone of the shaft. The members 230 are in the shape of recognizable indicia, for example letters that collectively define a logo. The members may be three dimensionally printed of the same or a different material compared to the core. For instance when the core frame 210 is printed of a metallic material, for example titanium, the impact resistant members 230 may be similarly printed of a metal material, or in other instances various plastic materials such as TPU to be used to provide desirable impact resistance.

The impact resistant members 230 are mounted onto the shaft after the placement of the reinforcement strips 218 within the channels 220 such that the members 230 overlap over an exterior of a portion of the composite material of the reinforcement strips. The plurality of members 230 are three-dimensional printed structures which are spaced longitudinally from one another in a row aligned along the length of the shaft while connecting adjacent ones of the members 230 by flexible strands 232 extending in the longitudinal direction of the shaft and allowing relative movement between adjacent members 230. In this manner, the impact resistant members 230 can be individually coupled to the shaft while allowing relative movement between the members 230 such that the members provide impact protection without affecting the flexing and resilient properties of the shaft defined by the lattice structure of the core 210 and the properties of the reinforcement strips 218 wrapped about the core. The strands 232 guide placement and alignment of the members 230 relative to one another. The impact resistant members 230 can be attached to the exterior of the core by various means including adhesive, welding, or mechanical coupling. In a preferred arrangement, lugs are provided on one of the impact resistant members 230 or the core 210 for being received within sockets formed in the opposing one of the members 230 and the core 210 to define a press fit or snap fit arrangement that retains the members 230 mounted externally on the core.

The blade may be similarly provided with an additional external member 234 for example formed of a resilient plastic or vulcanized rubber material which again overlaps an exterior portion of the core 210 and the reinforcement strips 218 wrapped about the core to provide impact protection and grip to the working face or faces of the blade. The external member 234 can be mechanically coupled such that it is replaceable using a similar arrangement of lugs on one member press fit into sockets formed on the opposing structure. The external member 234 can replace tape which is commonly used about the blade of a hockey stick for optimally gripping the puck.

The stick 200 can use multiple lattices styles running throughout the length of the stick, each lattice having different performance characteristics. A player wanting a more significant kick point (more flexible) stick will require a lattice that is spaced further apart along with thinner lattice beams. The blade of the stick has micro lattice, and these lattice structures will change based on how much blade flexibility the player desires.

The addition of a continuous carbon fiber strand woven around the player stick provides a continuous carbon fibre “tape” that is very strong and is nothing like the small strand fibers in a typical composite hockey stick. The process is called AFP or Automated Fiber Placement. In this instance, the continuous strand fiber is robotically placed into grooves that are manufactured into the shaft and blade of the stick. This wrapping of the titanium lattice structure follows a very specific path and affects performance characteristics of the shaft. The titanium lattice ensures the stick is light weight and strong, while the continuous carbon fiber weave allows the stick to return from its fully loaded position back to its original straight shape very quickly affording the player a faster shot. This duo of materials offers the players durability as well as increasing performance. The desired kick point is controlled for each player based on the style of titanium lattice and the number of layers of continuous carbon fiber that are applied. The term “spine” can be used when referring to the metal lattice structure of the sticks as the lattice is a good representation based on the human spine and how the bones in the spine changes in size and geometry as they run down the length of an individual's back.

Although not visible on the illustration, the shape of the stick can change from rectangular to an ovoid shape, or any other custom shape, for example at specified locations along the length of the shaft such as where the knob and transition meet to form handle grips and the like, simply by reconfiguring or modifying the programming instructions for the 3D printing equipment prior to forming the sporting implement. This feature cannot be easily manufactured with traditional composite sticks without the added cost of custom molds.

The transition area is where the bottom hand of the player moves back and forth throughout the game. Different textures are available, or a combination of different textures based on the players preferences. The troughs that are visible on the illustration indicate where the continuous carbon fiber is located.

The kick zone lattice varies for each player based on their desired flexibility and on their shooting preferences.

The blade consists of a series of micro-lattices combined with a continuous carbon fiber weave. This will give the blade the ability to flex and release the puck in ways traditional blades cannot.

Like the goalie stick the blade can have a vulcanized rubber insert that replaces tape. The insert protects the continuous carbon fiber strand and comes with various textures depending on what the players preferences are.

Turning now to FIGS. 34 to 36, when the sporting implement is formed as a 3D printed structure to define a lattice frame similarly to previous embodiments, and the printed structure again comprises a shaft 300 supporting a sporting tool such as a hockey stick blade at one end, the shaft 300 can be formed in a plurality of shaft sections 302 which are connected end to end with one another along the length of the shaft such that each shaft section spans a respective portion of the overall length of the shaft. The printed structure includes suitable connectors which are integrally printed together with the structure to form a junction 304 at each adjacent pair of the shaft sections 302. Three different embodiments of the configuration of the junction 304 are provided in the illustrated embodiments of FIGS. 34 through 36 as illustrative examples onlys.

In each instance, the junction 304 includes a female connector in the form of a socket 306 formed as an open end of a tubular structure at the end of one shaft section and one or more male connectors 308 protruding from the end of the adjacent shaft section for being matingly received in the female connector. Each shaft section includes an exterior profile 310 which is continuous along the length thereof and which transitions smoothly with the adjacent shaft section at each junction. The male connector 308 is reduced in outer diameter relative to the exterior profile 310 to define an annular shoulder 312 at the end of the exterior profile of the shaft section beyond which the male connector 308 protrudes. An outer diameter of the male connectors 308 fit closely within the interior diameter of the socket forming the female connector 306 to enable the male connector to be longitudinally slidable into the female connector to couple adjacent shaft sections at each junction. The shoulder 312 may be formed as a tapered surface which is sloped radially and longitudinally to form part of the boundary of a perimeter groove 314 described in further detail below.

The female socket 306 at the end of one of the shaft sections is surrounded by a tubular wall defining the exterior profile of the shaft section and which terminates as a beveled edge 316 which is sloped radially inward while protruding longitudinally of the shaft. In this manner, the interior edge of the wall surrounding the female socket 306 protrudes a greater distance in the longitudinal direction than the exterior profile and serves as a stop for abutment with the corresponding shoulder on the other shaft section. In this manner, when the male connector is fully inserted into the female connector and the beveled edge 316 at the end of the female section abuts the shoulder 312, a resulting perimeter groove 314 is defined in the gap between the exterior profiles of the abutted shaft sections.

The perimeter groove 314 may extend about the full circumference of the shaft or may extend circumferentially about part of the circumference at one or more circumferentially spaced positions about the circumference. Due to the beveled edge 316 at the end of the female section abutting the beveled shoulder 312 on the other shaft section, the resulting perimeter groove has respective boundaries formed in part by both the beveled edge 316 of the female shaft section and the shoulder 312 of the male shaft section. In this manner, filling the perimeter groove with suitable weld material provides a weld bead that is bonded to both shaft sections. Furthermore the weld material can fill the groove while being formed of the same material that the shaft sections are printed from so that the exterior profile of the shaft is continuous across the junction between the two shaft sections once welded with the weld bead being flush with the exterior profiles of the adjacent shaft sections.

Optionally, in some embodiments, material for forming the weld bead may be integrally formed as part of the 3D printed structure with one or both shaft sections in the form of a rib 318 which protrudes radially outward beyond the remainder of the exterior profile of the shaft and which extends circumferentially about the shaft along one of the boundary edges of the perimeter groove 314. The protruding rib may be provided on only one shaft section or may be provided in sections alternating between the shaft sections so that some portion of a protruding rib 318 extends along each portion of the perimeter groove about the circumference. The volume and mass of the rib 318 protruding beyond the remaining exterior profile or surface of the shaft is suitably size to correspond to the volume of the perimeter groove 314. By forming the rib integrally as a 3D printed structure together with the shaft sections of a heat formable material such as metal or plastic, the protruding rib can be melted and reshaped upon application of heat after the shaft sections have been mated by longitudinally inserting the male connector into the female connector, so that the rib forms weld material that fills the perimeter groove and immovably fixes the shaft sections permanently relative to one another. In this manner elongated shafts which are too long to be printed as one piece in some additive manufacturing equipment can instead be formed in sections in which subsequent coupling of the sections produces a perimeter groove with a protruding rib alongside the groove that can be subsequently used as a weld bead to fill the groove upon application of heat during a subsequent assembly step. Once welded, the exterior surface is continuous across the junction between the shaft sections.

Turning now more particularly to the embodiment in FIG. 34, the male connector in this instance may comprise a tube of reduced diameter relative to the exterior profile which is press-fit into the corresponding female connector of the other shaft section. Once fully connected by longitudinal sliding of the shaft sections relative to one another until the stop of one section abuts the shoulder of the other section, a separate bead of weld material can be applied to fill the groove and weld the shaft sections to one another.

In the embodiment of FIG. 35, both shaft sections may be formed with a female socket 36 at the end thereof with a plurality of male connectors 38 protruding beyond the end of the exterior profile at a plurality of circumferentially spaced positions which are circumferentially offset from the male connectors of the other shaft section. In this manner, a series of male connectors are provided spanning across the junction which alternate in the circumferential direction between being mounted on one shaft section or the other shaft section. The end of the exterior profile of each female section about the circumference is again provided with a beveled edge that aligns with the beveled shoulder 312 at the base of each male connector so that a continuous perimeter groove 314 is again formed when the shaft sections are fully coupled by the male and female connectors. In this instance, the protruding rib 318 of weld material is integrally formed in separate circumferential sections aligned with each male connector so that part of the protruding rib extends along different boundaries of the perimeter groove 314 about the circumference thereof. The function of the rib remains identical in that application of heat to the rib causes the rib to be melted and reshaped to fill the perimeter groove as a weld bead so that the exterior profile is again continuous across the junction subsequent to a welding step.

In the embodiment of FIG. 36, one of the shaft sections again terminates at a beveled edge 316 about the full circumference thereof however the other shaft section mounting the male connector 308 thereon is provided with a plurality of male connectors in the form of longitudinally extending fingers 320 that are circumferentially spaced apart relative to one another such that individual fingers are sufficiently flexible that they can flex radially inwardly slightly relative to one another in a resilient manner while being biased to return to an unflexed position. Each finger is provided with a radially protruding catch 322 formed thereon which fits within a corresponding recess having a shoulder 324 defined thereon which retains the catch 322 thereon when the male connectors are fully inserted into the female connector. The fingers 320 thus form a snapfit arrangement with corresponding recesses of the other shaft section which provides a mechanical coupling that snugly retains the shaft sections coupled to one another before welding. The protruding rib 318 in this instance is mounted about the full circumference of the exterior shoulder 312 of the male shaft section so that application of heat to the rib 318 again produces suitable weld material that fills the perimeter groove 314 to remotely join the shaft sections.

Turning out to FIGS. 37 and 38, two examples of a lattice structure for defining the lattice frame of the shaft of a sporting implement are illustrated in which mechanical properties of the shaft vary along a gradient portion 400 of the shaft. When used in a sporting implement having a tool such as a hockey blade at one end of the shaft, the gradient portion 400 is preferably located in proximity to the blade, corresponding to a kick zone at the lower portion of the shaft nearest to the blade.

The gradient portion 400 may be provided along a portion of the length of a shaft having a lattice frame defining an external shell of a hollow tubular structure or a lattice frame defining the internal core of a shaft. In each instance the lattice frame is configured such that an attribute of the lattice such as a measure of an aspect of the geometry or a sizing attribute such as the beam diameter or the node spacing which affects the density of the lattice, is gradually varied along a corresponding portion of the length of the shaft. In each instance, the gradient is configured such that the attribute gradually increases or decreases towards a central apex and then gradually decreases or increases again as the lattice frame extends in the longitudinal direction between two adjacent lattice portions. Each of the adjacent lattice portions in the illustrated embodiment have attributes that remain constant along the length of that portion of the shaft. By gradually increasing or decreasing an attribute of the lattice, a region of increased strength or increased flexibility can be introduced into the lattice frame along a portion of the length of the shaft, without introducing a high stress point where the attributes of the lattice frame suddenly change at an abrupt transition between adjacent zones or portions of the length of the shaft.

In the first embodiment of FIG. 37, the lattice frame includes a plurality of beams 404 connected between nodes 406 such that the beams extend along three or more different axes relative to one another. The beam diameters remain constant across the gradient portion 400 for all except the beams along a primary axis in the longitudinal direction of the shaft which is gradually reduced and gradually increased across the gradient portion. In further embodiments, the node spacing or another sizing attribute such as beam angle or number of beams can vary to affect the density along a gradient which in turn affects the flexibility of the resulting lattice frame.

Alternatively, as shown in FIG. 38, the sizing attribute of all beams aligned along multiple different axes may be gradually reduced and gradually increased again across the length of the gradient portion so as to similarly achieve a transition zone with mechanical properties such as flexibility which are gradually increased and gradually decreased over the gradient portion.

The attribute that varies across the gradient portion may vary linearly or non-linearly along the length of the shaft. The exterior profile remains continuous across the gradient portion 400 and across the junction to each of the adjacent lattice portions 402 having constant properties along the length thereof.

Turning now to FIGS. 39 through 41, in this instance, the sporting implement is a hockey stick having a shaft 500 and a blade 502 at one end of the shaft which are collectively formed by a combination of a lattice frame 504 formed by a three-dimensional printed structure and a plastic insert 506 which is mounted externally on the lattice frame to define a portion of the exterior surface of the assembled hockey stick. In the preferred embodiment, the insert 506 comprises a single body of thermoplastic polyurethane material which can be formed in a mould. The majority of the exterior surface of the finished and assembled hockey stick remains defined by the lattice frame 504; however, the lattice frame includes recesses formed at the exterior thereof in which the lattice frame is recessed inwardly into the interior of the body of the hockey stick relative to the exterior boundary of the assembled stick so that the insert 506 can be mounted into the recess. More particularly, the insert 506 fills the recess and is mounted flush with the surrounding exterior surfaces defined by the lattice frame.

In the illustrated embodiment, the blade 502 is a curved blade having a concave front face 510, a concave rear face 512, and a bottom edge 514 connected between the front and rear faces along the length of the blade between the heel end joined to the shaft and the distal toe end of the blade. The recess is formed in part of the front face 510 and part of the rear face 512 along respective portions adjacent to the bottom edge 514 so that the insert may be formed as a U-shaped profile extending along the length of the blade between the heel end and the toe end thereof.

More particularly, the recess includes a front cavity 516 in the front face of the blade which extends along the bottom portion of the blade along the full length of the blade while spanning upwardly from the bottom edge by more than half the overall height of the blade while the remaining upper portion of the front face of the blade above the cavity 516 maintains an exterior boundary surface defined by the lattice frame. The overall height of the cavity, and the corresponding insert 506 inserted therein is greater than the height of a puck while being formed such that the height increases slightly towards the toe end which typically is involved more in the handling of a puck.

The recess also includes a rear cavity 518 in the rear face of the blade which also spans the full length of the blade between the heel end and the toe end while being reduced in height to span less than half the height of the blade from the bottom edge. The overall height remains equal to or greater than the height of a typical puck so that the handling of a puck is primarily engaged by the insert filling the rear cavity 518 rather than the lattice frame which defines the remainder of the exterior boundary at the rear face of the blade above the insert.

The bottom side of the lattice frame is fully recessed relative to the bottom boundary of the assembled hockey stick such that the bottom boundary is substantially fully defined by the insert 506 in the assembled position. The insert 506 thus includes (i) a forward portion 520 fully occupying the front cavity 516 so that the front face is substantially flush with the surrounding exterior boundary defined by the lattice frame, (ii) a rearward portion 522 fully occupying the rear cavity 518 so that the rear face is substantially flush with the surrounding exterior boundary defined by the lattice frame, and (iii) a bottom portion 524 fully defining the bottom edge of the assembled blade while being connected between the forward portion and the rearward portion at the bottom of the blade along the full length of the blade to define the U-shaped profile of the insert along the length thereof.

The insert can be retained relative to the lattice frame by a mechanical coupling of various configurations. In the illustrated embodiment, the forward portion of the insert 506 includes male connectors 526 formed on the rear face of the forward portion 520 for alignment with corresponding sockets formed integrally as part of the printed lattice frame. The male connectors 526 may include catches formed thereon which cooperate with undercut shoulders formed into the lattice frame so that the connectors form a snap-fit connection that securely retains the insert 506 mounted within the recess in the lattice frame while enabling the insert 506 to be readily released and replaced when desired. Connectors 526 on the forward portion 520 is sufficient to retain the entirety of the insert mounted relative to the lattice frame at the bottom portion and rearward portion due to the geometry of the insert closely matching the geometry of the recess within which the insert is received.

The external or forward face of the forward portion 520 may be provided with a plurality of gripping protrusions 528 in the form of semi-spherical domes or other shapes protruding from a remaining primary surface 532 of the insert which is flush with the adjacent external surfaces of the lattice frame. The protrusions 528 can be spaced apart in a grid pattern in which the protrusions are provided at a narrower spacing and with increased density towards the lower portion of the blade most frequently contacting pucks, while being less dense at an increased spacing with increasing distance from the bottom edge of the blade. The rear surface of the rearward portion 522 of the insert at the rear of the blade may be provided with a similar configuration of gripping texture if desired.

The bottom portion of the insert at the bottom edge may also include a primary surface defining the majority of the external surface at the bottom of the blade and one or more protrusions 530 in the form of longitudinally extending ribs extending along the full length of the blade. The ribs 530 protrude from a remaining primary surface of the insert and act as runners providing a sliding contact with the ice surface but with a reduced dimension to reduce friction.

In yet further embodiments, the concepts described above with regard to construction of a customizable lattice structure or frame formed by 3D printing can be applied to a variety of other sporting implements including an alpine ski pole, a cross country ski pole as shown in FIGS. 43A and 43B, a baseball bat as shown in FIGS. 42A and 42B, a cricket bat as shown in FIG. 44, a golf club, a tennis racket, or other styles of hockey sticks such as a Dek hockey stick, a bandy stick, or a field hockey stick. In each instance, when the sporting implement comprises a shaft and a sporting tool at one end of the shaft (such as a hockey blade, a golf club head, a mesh frame of a racket, a barrel of a baseball bat, etc.), the shaft can be constructed as described above include features of the lattice frame with the optional addition of a filament wrap in various manners described. The customizable lattice frame and features of the shafts described above can also be applied to individual frame members of a frame assembly such as the frame members of a bicycle frame and the like. Additional features such as the plastic insert 506 can also be applied to any of the sporting implements described above to introduce impact protection, grip or other benefits achieved by the composite structure of a lattice frame with a molded plastic insert as described herein.

Since various modifications can be made in the invention as herein above described, and many apparently widely different embodiments of same made, it is intended that all matter contained in the accompanying specification shall be interpreted as illustrative only and not in a limiting sense.

1. A sporting implement comprising:
a shaft arranged to be gripped by a user; and
a sporting tool formed at one end of the shaft;
wherein at least the shaft is formed of a customizable 3-dimensional printed structure.

2. The sporting implement according to claim 1 wherein the 3-dimensional printed structure includes a 3-dimensional lattice structure forming the shaft, wherein exterior boundary walls of the shaft are defined by the lattice structure such that the lattice structure remains exposed at the boundary walls along a length of the shaft.

3. The sporting implement according to claim 2 wherein a cross sectional shape of the shaft is rectangular so as to define four corner edges and wherein the 3-dimensional lattice structure includes a corner member spanning continuously along the length of the shaft at each of the four corner edges.

4. The sporting implement according to claim 2 or claim 3 wherein at least one size attribute of the lattice structure varies gradually along a gradient portion of the length of the shaft.

5. The sporting implement according to any one of claims 1 through 4 wherein the 3-dimensional printed structure includes a 3-dimensional lattice structure forming boundary walls of the sporting tool.

6. The sporting implement according to any one of claims 1 through 5 wherein the 3-dimensional printed structure is formed of metal or composite.

7. The sporting implement according to any one of claims 1 through 5 wherein the 3-dimensional printed structure comprises para-aramid fibers.

8. The sporting implement according to any one of claims 1 through 7 wherein the shaft comprises boundary walls forming an outer tube extending in a longitudinal direction along a length of the shaft and a plurality of stiffener flanges protruding inwardly from the boundary walls partway across a hollow interior of the outer tube.

9. The sporting implement according to claim 8 wherein the stiffener flanges are oriented transversely to the longitudinal direction and are arranged in a repeating array pattern along the length of the shaft.

10. The sporting implement according to any one of claims 1 through 9 wherein the shaft comprises boundary walls forming an outer tube extending in a longitudinal direction along a length of the shaft and a plurality of dimples formed by the 3-dimensional printed structure in a grid pattern within the boundary walls to protrude inwardly into a hollow interior of the outer tube.

11. The sporting implement according to any one of claims 1 through 10 wherein the shaft comprises boundary walls forming an outer tube extending in a longitudinal direction along a length of the shaft and a plurality of openings formed by the 3-dimensional printed structure in a grid pattern within the boundary walls.

12. The sporting implement according to claim 11 further comprising a plurality of stiffener flanges protruding inwardly from the boundary walls, wherein at least some of the stiffener flanges comprise annular flanges in which each annular flange surrounds a respective one of the openings in the boundary walls of the shaft to protrude inwardly from an inner surface of the boundary walls.

13. The sporting implement according to any one of claims 1 through 12 wherein the sporting implement is a hockey stick and the sporting tool is a blade comprising a front face, a rear face, and a plurality of openings formed by the 3-dimensional printed structure so as to extend through the blade between the front face and the rear face in a grid pattern.

14. The sporting implement according to any one of claims 1 through 13 wherein the 3-dimensional printed structure defines boundary walls of the shaft forming an outer tube extending in a longitudinal direction along a length of the shaft, each boundary wall comprising:
(i) a plurality of structural nodes arranged in a 2-dimensional array; and
(ii) a plurality of struts extending in a direction of the 2-dimensional array and being interconnected between respective pairs of the structural nodes of the 2-dimensional array;
wherein at least some of the struts comprises overlapping struts that each overlap transversely across a different corresponding one of the overlapping struts so as to allow relative movement between the overlapping struts.

15. The sporting implement according to claim 14 wherein the structural nodes are arranged in a rectangular grid pattern so as to be spaced apart from one another along first and second axes of the rectangular grid pattern, and wherein each structural node is connected with four rectangularly adjacent nodes among said structural nodes by four Cartesian struts among the struts in which the cartesian struts extending along the first or second axes, and wherein each structural node is further connected with four diagonally adjacent nodes among said structural nodes by four of the overlapping struts.

16. The sporting implement according to claim 14 or claim 15 wherein there is a gap extending perpendicularly to the direction of the 2-dimensional array between each overlapping strut and the corresponding overlapping strut.

17. The sporting implement according to any one of claims 1 through 16 wherein the sporting implement is a hockey stick and the sporting tool is a blade, and wherein the 3-dimensional printed structure comprises (i) a first printed structure including the blade and a first shaft section forming a first lengthwise portion of the shaft, and (ii) a second printed structure including a second shaft section forming a second lengthwise portion of the shaft, the first and second structures being arranged for mating connection with one another to define the sporting implement.

18. The sporting implement according to claim 17 wherein one of the first printed structure and the second printed structure comprises a male connector formed thereon as part of the 3-dimensional printed structure and another one of the first printed structure and the second printed structure comprises a female connector formed thereon as part of the 3-dimensional printed structure, the male connector and the female connector forming said mating connection.

19. The sporting implement according to claim 18 wherein a perimeter groove is formed to extend at least partway about a circumferent of the shaft at a junction between the first and second printed sections when the first and second printed sections are joined in abutment with one another, and wherein the perimeter groove is filled with a weld material which is identical to a material of the first and second printed sections so as to immovably fix the first and second printed sections relative to one another.

20. The sporting implement according to any one of claims 1 through 19 wherein the shaft of the 3-dimensional printed structure includes an outer boundary surface and grooves integrally formed therein which are recessed relative to the outer boundary surface and which define indicia representing letters or numbers.

21. The sporting implement according to any one of claims 1 through 20 wherein the shaft of the 3-dimensional printed structure includes an outer boundary surface and protruding members integrally formed thereon which protrude relative to the outer boundary surface and which enhance user grip about the shaft.

22. The sporting implement according to claim 21 wherein the protruding members are located at an intermediate location partway along the shaft between the sporting tool and an opposing end of the shaft.

23. The sporting implement according to claim 21 wherein the protruding members are located in proximity to one end of the shaft opposite from the sporting tool.

24. The sporting implement according to claim 21 wherein the sporting implement comprises a goalie hockey stick and the sporting tool comprises a blade, and wherein the shaft comprises a lower paddle portion adjacent the blade and an upper gripping portion extending above lower paddle portion, wherein the upper gripping portion is narrower in width than the lower paddle portion, and wherein the protruding members are located on the upper gripping portion in proximity to the lower paddle portion.

25. The sporting implement according to any one of claims 1 through 24 wherein the sporting implement comprises a goalie hockey stick and the sporting tool comprises a blade formed with the shaft as part of the 3-dimensional printed structure, and wherein the blade of the 3-dimensional printed structure includes (i) an outer boundary surface and (ii) protruding members integrally formed thereon which protrude relative to the outer boundary surface, the protruding members providing enhanced grip to the outer boundary surface of the blade.

26. The sporting implement according to claim 25 wherein each protruding member includes at least one corner edge formed at an acute angled intersection of two surfaces of the protruding member.

27. The sporting implement according to claim 26 wherein each protruding member includes a socket formed therein such that the corner edge of the protruding member is defined about a perimeter of the socket.

28. The sporting implement according to any one of claims 1 through 27 wherein the 3-dimensional printed structure comprises a lattice frame formed of metal and extending along a length of the shaft and wherein the sporting implement further comprises at least one reinforcement strip wrapped about a portion of the lattice frame, said at least one reinforcement strip being formed of a composite fibre and resin material which extends as a unitary member along a majority of a length of the shaft.

29. The sporting implement according to any one of claims 1 through 27 wherein the sporting implement comprises a hockey stick and the sporting tool comprises a blade formed with the shaft as part of the 3-dimensional printed structure, the printed structure of the blade further comprising at least one recess in a surface of the blade, and the sporting implement further comprising a plastic insert mounted into the recess to define a portion of an exterior surface of the blade.

30. A method of manufacturing the sporting implement according to any one of claims 1 through 29, the method comprising:
receiving one or more user selections relating to a configuration of the sporting implement;
modifying 3-dimensional printing instructions according to the one or more user selections relating to the configuration of the sporting implement; and
printing the 3-dimensional printed structure according to the modified 3-dimensional printing instructions.

31. A blade holder for mounting a skate blade onto a skate boot, the blade holder comprising:
a lower blade mounting portion arranged to mount the skate blade thereon; and
an upper boot mounting portion arranged to be mounted onto a bottom of the skate boot;
wherein the lower blade mounting portion and the upper boot mounting portion are joined as a unitary body formed of a customizable 3-dimensional printed structure.

32. The blade holder according to claim 31 in combination with the skate blade, wherein said unitary body formed of the customizable 3-dimensional printed structure includes the skate blade.

33. The blade holder according to claim 32 wherein the skate blade includes (i) an upper portion joined to the blade holder and extending along at least a portion of a length of the blade, the upper portion comprising a 3-dimensional lattice structure, and (ii) a lower portion below the upper portion to define a bottom edge of the blade, the lower portion being solid along the length of the blade.

34. The blade holder according to any one of claims 31 through 33 wherein the upper boot mounting portion includes a front pedestal and a rear pedestal arranged to be joined to the skate boot at spaced apart locations, each pedestal comprising a tubular boundary wall defining a hollow column and a plurality of wall openings formed in the tubular boundary wall at spaced apart locations in an array pattern, the tubular boundary wall and the wall openings being formed as part of the 3-dimensional printed structure.

35. The blade holder according to claim 34 further comprising a plurality of stiffener flanges protruding inwardly from the tubular boundary wall partway across a hollow interior of the hollow column, the stiffener flanges being situated between the openings in the tubular boundary wall.

36. The blade holder according to any one of claims 31 through 35 wherein at least some of the stiffener flanges comprise annular flanges, each annular flange surrounding a respective one of the wall openings in the tubular boundary wall to protrude inwardly from an inner surface of the tubular boundary wall.

37. The blade holder according to any one of claims 31 through 36 in combination with an alignment tool comprising an elongate mounting member and an elongate guide member joined perpendicularly to one another, wherein the blade holder comprises a first horizontal socket formed at a toe end of the blade holder and a second horizontal socket formed at a heel end of the blade holder, each socket being arranger to receive the mounting member of the alignment tool longitudinally slidably therein such that the guide member extends vertically upwardly therefrom to locate a lateral center of the blade holder relative to the skate boot.

38. A method of manufacturing the blade holder according to any one of claims 30 through 37, the method comprising:
receiving one or more user selections relating to a configuration of the blade holder, the user selections including a blade profile radius, a fastener pattern of the upper boot mounting portion, a heel height, and/or a radius of an edge of the blade;
modifying 3-dimensional printing instructions according to the one or more user selections relating to the configuration of the blade holder; and
printing the 3-dimensional printed structure according to the modified 3-dimensional printing instructions.

39. A hockey goalie mask comprising:
a main body portion arranged to be worn about a head of a user so as to cover a jaw, a forehead, and temporal regions of the head of the user, the main body portion including a viewing region comprising a plurality of viewing openings for alignment with eyes of the user when the main body portion is worn about the head of the user; and
at least one bar member spanning across the viewing region between respective ones of the viewing openings so as to define at least part of the boundary of said respective ones of the viewing openings;
wherein the main body portion and said at least one bar member are joined as a unitary body formed of a customizable 3-dimensional printed structure.

40. The hockey goalie mask according to claim 39 wherein the main body portion and the at least one bar member are formed continuously with one another from a common metallic material.

41. A method of manufacturing the hockey goalie mask according to claim 39 or 40, the method comprising:
receiving one or more user selections relating to a configuration of the hockey goalie mask, the user selections including a shape of the main body portion, a configuration of the viewing openings, and/or a configuration of said at least one bar member;
modifying 3-dimensional printing instructions according to the one or more user selections relating to the configuration of the hockey goalie mask; and
printing the 3-dimensional printed structure according to the modified 3-dimensional printing instructions.

42. A sporting implement for use in playing a sport, the sporting implement comprising:
a frame assembly defining a structural frame of the sporting element;
wherein the structural frame is formed of a customizable 3-dimensional printed structure.

43. The sporting implement according to claim 42 wherein the frame assembly defines the structural frame of a golf club.

44. The sporting implement according to claim 42 wherein the frame assembly defines the structural frame of a tennis racket.

45. The sporting implement according to claim 42 wherein the frame assembly defines the structural frame of a bicycle chassis.

46. A method of manufacturing the sporting implement according to any one of claims 42 through 45, the method comprising:
receiving one or more user selections relating to a configuration of the sporting element;
modifying 3-dimensional printing instructions according to the one or more user selections relating to the configuration of the sporting implement; and
printing the 3-dimensional printed structure according to the modified 3-dimensional printing instructions.

47. A sporting implement comprising:
a shaft arranged to be gripped by a user; and
a sporting tool arranged to be supported on one end of the shaft;
wherein at least one of the shaft and the tool comprises (i) a lattice frame formed of a 3-dimensional printed lattice structure and extending along a length of the at least one of the shaft and the tool, and (ii) at least one reinforcement strip wrapped about a portion of the lattice frame; and
wherein said at least one reinforcement strip is formed of a composite fibre and resin material which extends as a unitary member along a majority of said length.

48. The sporting implement according to claim 47 wherein said at least one reinforcement strip comprises a flat band of material.

49. The sporting implement according to claim 47 or 48 wherein said at least one reinforcement strip includes continuous fibre members spanning a full length of the reinforcement strip.

50. The sporting implement according to any one of claims 47 through 49 wherein the shaft and the sporting tool are both formed of said lattice frame and said at least one reinforcement strip is wrapped helically about the lattice frame.

51. The sporting implement according to any one of claims 47 through 50 wherein the lattice frame is formed in sections spanning respective portions of the length of the shaft and wherein said at least one reinforcement strip extends continuously across the sections of the core to bridge the sections.

52. The sporting implement according to any one of claims 47 through 51 wherein said at least one reinforcement member extends helically about the lattice frame.

53. The sporting implement according to claim 52 wherein a helix angle of said at least one reinforcement strip varies along said. length of the at least one of the shaft and the tool.

54. The sporting implement according to claim 53 wherein the shaft comprises the lattice frame and wherein a lower portion of the shaft adjacent to the sporting tool has a different helix angle from an upper portion of the shaft distal from the sporting tool.

55. The sporting implement according to any one of claims 47 through 54 wherein the lattice frame includes at least one channel recessed into an exterior boundary of the lattice frame, said at least one channel receiving said at least one reinforcement strip at least partially recessed therein.

56. The sporting implement according to claim 55 wherein said at least one reinforcement strip is fully recessed within said at least one channel.

57. The sporting implement according to claim 55 or claim 56 wherein said at least one reinforcement strip is flush mounted relative to the exterior boundary of the lattice frame along at least an intermediate portion at an intermediate location along the length of the at least one of the shaft and the tool.

58. The sporting implement according to any one of claims 55 through 57 wherein said at least one reinforcement strip is recessed relative to boundary walls of said at least one channel along at least a portion of the length of the at least one of the shaft and the tool.

59. The sporting implement according to any one of claims 55 through 58 further comprising at least one protruding rib formed integrally with the lattice core and extending alongside said at least one channel, in which said at least one protruding rib protrudes outwardly from the exterior boundary of the core.

60. The sporting implement according to any one of claims 47 through 59 further comprising a plurality of openings formed in boundary walls of said at least one channel and receiving resin of said composite fibre and resin material at least partially therein.

61. The sporting implement according to any one of claims 47 through 60 wherein said at least one channel in cross section along a plane extending longitudinally along the at least one of the shaft and the tool defines a pair of longitudinally opposed boundary walls which are sloped outwardly in a common direction longitudinally of the at least one of the shaft and the tool.

62. The sporting implement according to any one of claims 47 through 61 further comprising a plurality of impact resistant members supported externally on the shaft along a lower portion of the shaft adjacent to the sporting tool so as to extend externally over a portion of said at least one reinforcement strip.

63. The sporting implement according to any one of claims 47 through 62 wherein the lattice frame is formed of metal.

64. A sporting implement comprising:
a shaft arranged to be gripped by a user and being formed at least in part with a composite fibre and resin material;
a sporting tool protruding from one end of the shaft; and
at least one impact resistant member formed of plastic material and supported externally on (i) the shaft along a lower portion of the shaft adjacent to the sporting tool or (ii) on the sporting tool so as to extend externally over said composite fibre and resin material.

65. The sporting implement according to claim 64 wherein the at least one impact resistant member comprises a plurality of impact resistant members supported on the shaft and connected to one another by flexible strands extending longitudinally of the shaft.

66. The sporting implement according to claim 64 or claim 65 wherein the at least one impact resistant member is mechanically coupled to the shaft or the sporting tool so as to be releasable from the shaft or the sporting tool.

67. A sporting implement comprising:
a shaft arranged to be gripped by a user, the shaft comprising a lattice frame extending along a length of the shaft, in which the lattice frame is formed of a 3-dimensional printed lattice structure; and
a sporting tool formed at one end of the shaft;
wherein at least one of a geometry and a density of the lattice frame varies gradually along a gradient portion of the length of the shaft.

68. The sporting implement according to claim 67 wherein said at least one of the geometry and the density is a size attribute of the lattice frame which varies gradually along said gradient portion of the length of the shaft.

69. The sporting implement according to claim 68 wherein said at least one size attribute of the lattice frame corresponds to a beam diameter of beams aligned in one axial direction, the beam diameter of the beams along said one axis varying in thickness gradually along said gradient portion of the length of the shaft.

70. The sporting implement according to claim 68 wherein said at least one size attribute of the lattice frame corresponds to a beam diameter of beams aligned in a plurality of different axial directions, the beam diameter of the beams along said plurality of different axial directions varying in thickness gradually along said gradient portion of the length of the shaft.

71. The sporting implement according to any one of claims 68 through 70 wherein said size attribute varies linearly along the gradient portion of the length of the shaft.

72. The sporting implement according to any one of claims 67 through 71 wherein an exterior profile of the shaft remains constant along said gradient portion of the length of the shaft.

73. The sporting implement according to any one of claims 67 through 72 wherein the sporting implement comprises a hockey stick and the sporting tool comprises a blade, said gradient portion of the length of the shaft is proximate to the blade.

74. The sporting implement according to any one of claims 67 through 73 wherein the shaft is formed in sections spanning respective portions of the length of the shaft and being joined to one another at one or more junctions, and wherein said gradient portion of the length of the shaft is wholly contained within one of the sections of the shaft.

75. A sporting implement comprising:
a shaft arranged to be gripped by a user, the shaft comprising a lattice frame extending along a length of the shaft, in which the lattice frame is formed of a 3-dimensional printed lattice structure; and
a sporting tool formed at one end of the shaft;
wherein the shaft is formed in shaft sections spanning respective portions of the length of the shaft and being joined to one another at one or more junctions between corresponding adjacent pairs of the shaft sections; and
wherein each junction further comprises:
a male connector formed on one of the shaft sections of the corresponding adjacent pair;
a female connector formed on another one of the shaft sections of the corresponding adjacent pair, the female connector receiving the male connector slidably therein longitudinally of the shaft; and
a perimeter groove extending circumferentially at least partway about the shaft when the male connector is fully inserted into the female connector;
wherein the perimeter groove has boundary surfaces defined in part on both shaft sections of the corresponding adjacent pair whereby a bead of weld material received within the perimeter groove immovably fixes the shaft sections relative to one another.

76. The sporting implement according to claim 75 in combination with the bead of weld material, the bead of weld material being formed of the same material as the shaft sections, and the bead of weld material filling the perimeter groove of the respective junction such that an exterior profile of the shaft is continuous across the junction between the shaft sections.

77. The sporting implement according to claim 75 wherein each junction further comprises a rib protruding from one of the shaft sections alongside the perimeter groove, the rib being formed integrally as part of the 3-dimensional printed lattice structure, and the rib being sized to form a weld bead that substantially fills the perimeter groove upon application of heat to reform the rib into the weld bead.

78. The sporting implement according claim 77 wherein each junction further includes the rib being formed on the shaft section having the male connector formed thereon.

79. The sporting implement according any one of claims 75 through 78 wherein each junction further comprises a stop formed on one of the shaft sections so as to longitudinally abut a corresponding portion of the other one of the shaft sections when the male connector is fully inserted into the female connector.

80. The sporting implement according any one of claims 75 through 79 wherein each junction further comprises a mechanical connector to resist removal of the male connector from the female connector once the male connector has been fully inserted into the female connector.

81. A sporting tool for a sporting implement having a shaft arranged to be gripped by a user, the sporting tool comprising:
a hockey blade arranged to be mounted at one end of the shaft, in which the hockey blade comprises a lattice frame formed of a 3-dimensional printed structure;
the 3-dimensional printed structure defining at least one recess in a surface of the blade; and
a plastic insert mounted into the recess to define a portion of an exterior surface of the blade.

82. The sporting tool according to claim 81 wherein an exterior surface of the plastic insert is substantially flush with an exterior surface of an adjacent portion of the lattice frame.

83. The sporting tool according to claim 81 or claim 82 wherein the insert is fixed to the lattice frame by a mechanical coupling.

84. The sporting tool according to claim 83 wherein the insert is fixed to the lattice frame solely by the mechanical coupling and wherein the mechanical coupling is readily releasable.

85. The sporting tool according to any one of claims 81 through 84 wherein the surface of the blade locating the recess therein includes a portion of a concave front face of the blade.

86. The sporting tool according to any one of claims 81 through 85 wherein the surface of the blade locating the recess therein includes a portion of a convex rear face of the blade.

87. The sporting tool according to any one of claims 81 through 86 wherein the surface of the blade locating the recess therein includes a portion of a concave front face of the blade, a portion of a convex rear face of the blade, and a portion of a bottom edge of the blade between the front face and the rear face, and wherein the insert comprises a single body having a generally U-shaped profile received within respective portions of the recess in the front face, the bottom edge and the rear face respectively.

88. The sporting tool according to claim 87 wherein the bottom edge includes a primary surface oriented transversely to the front and rear faces and at least one protrusion protruding longitudinally of the shaft from the primary surface.

89. The sporting tool according to claim 86 wherein said at least one protrusion on the bottom edge comprises a rib extending along a majority of a length of the blade.

90. The sporting tool according to any one of claims 81 through 89 wherein the insert includes a primary surface defining at least a portion of a concave front face or a convex rear face of the blade and a plurality of spaced apart gripping protrusions protruding outwardly from the primary surface at spaced apart locations to define a gripping texture.

91. The sporting tool according to claim 90 wherein a spacing between adjacent gripping protrusions varies across the primary surface of the insert.

92. The sporting tool according to any one of claims 81 through 91 in combination with the shaft, the shaft also being formed of said lattice frame such that the 3-dimensional printed structure of the lattice frame extends along a length of the shaft.

93. A hockey stick comprising:
a shaft arranged to be gripped by a user, the shaft comprising a first shaft section forming a first lengthwise portion of the shaft, and a second shaft section forming a second lengthwise portion of the shaft, the first and second structures being arranged for mating connection with one another to define the shaft; and
a hockey blade arranged to be mounted on the first shaft section at one end of the shaft;
wherein at least the hockey blade comprises a lattice frame formed of a metallic 3-dimensional printed structure defining the hockey blade and the first shaft section of the shaft.

94. The hockey stick according to claim 93 wherein the hockey blade comprises a front face, a rear face, and a plurality of openings formed by the 3-dimensional printed structure such that the openings extend through the blade between the front face and the rear face in a grid pattern.

95. The hockey stick according to claim 93 or 94 wherein the 3-dimensional printed structure of the hockey blade includes (i) an outer boundary surface and (ii) protruding members integrally formed thereon which protrude relative to the outer boundary surface, the protruding members providing enhanced grip to the outer boundary surface of the blade.
